(19) United States
(12) Patent Application Publication
(10) Pub. No.: US 2025/0263136 A1
(43) Pub. Date: Aug. 21, 2025

(54) AERODYNAMIC FAIRING FOR A CARGO BODY

(71) Applicant: TRANSTEX INC., Montréal (CA)

(72) Inventors: Pierre-Yves LACROIX, Laval (CA); Jacques LECLERC, Pierrefonds (CA); Alexandre DERNY, Roxboro (CA); Mathieu BOIVIN, Mont-Royal (CA); Philippe PICCHIOTTINO, Ottawa (CA); Paul R. PROVENCHER, Laval (CA); Félix LESSARD, Boucherville (CA); Eduardo A. J. RUIZ, Laval (CA)

(21) Appl. No.: 19/198,990

(22) Filed: May 5, 2025

Related U.S. Application Data
(63) Continuation of application No. 17/532,892, filed on Nov. 22, 2021, now Pat. No. 11,975,769.
(60) Provisional application No. 63/735,402, filed on Dec. 18, 2024.

(51) Int. Cl. B62D 35/00

(52) U.S. Cl. CPC B62D 35/001

(57) ABSTRACT

An aerodynamic fairing for a cargo body is adapted to decrease drag generated by the moving cargo body. The fairing has a top wall providing a surface for guiding air thereover; and members extending away from the top wall, with bottom parts of the members, distant to the top wall, providing a mounting surface to mount the fairing to the cargo body. The fairing can be mounted to the cargo body using brackets allowing the fairing to expend and contract freely and to span over the whole width of the cargo body. The top fairing is economical to produce, being potentially made of extruded material.

### CROSS-REFERENCE TO RELATED APPLICATION

This application relates to and is a Continuation-In-Part application claiming priority under 35 U.S.C. §0 120 from U.S. patent application Ser. No. 18/656,255, filed May 6, 2024, under 35 U.S.C. § 111, entitled AERODYNAMIC APPARATUSES FOR TRAILER, relates to and is a Continuation application claiming priority under 35 U.S.C. § 120 from U.S. patent application Ser. No. 17/532,892, filed Nov. 22, 2021, under 35 U.S.C. §0 111, published May 25, 2023 under publ. No. US2023/0159113A1, entitled AERODYNAMIC APPARATUSES FOR TRAILER, the specifications of which are hereby incorporated herein by reference in its entirety. This application further relates to and is a non-provisional application claiming priority under 35 U.S.C. §0 119(e) and 37 C.F.R. § 1.78(a) for a priority claim to earlier-filed provisional application, Ser. No. 63/735,402, filed Dec. 18, 2024, under 35 U.S.C. §0 111, entitled AERODYNAMIC FAIRING FOR A CARGO BODY, the specification of which is hereby incorporated herein by reference in its entirety.

### BACKGROUND

### (a) Field

The subject matter of the present invention relates to an end-of-trailer fairing that improves aerodynamic performance of the trailer. More particularly, the present application involves a fairing that features a specific geometric shape that includes a leading curved portion and a trailing curved portion that meet at a point of tangency.

### (b) Related Prior Art

Trailers towed by trucks and similar apparatuses for transporting cargo can be large, unwieldy, and include geometries which invite inefficiencies during travel. One aspect of these inefficiencies concerns the aerodynamics of the trailer. In an effort to improve trailer aerodynamics, trailers have been built, supplemented, or retrofitted with trailer skirts (or side skirts), devices affixed to the underside which limit air circulating in the empty space between the trailer's axles. By reducing the amount of airflow in this space, drag caused by turbulence is reduced and permits the trailer to be towed more efficiently, increasing the gas mileage and performance of the vehicle and its cargo. Other ways of improving aerodynamic performance of the trailer involves the provision of fairings to the end of the trailer. The fairings modify the airflow around or behind of the end of the trailer to reduce drag. It is known to produce fairings that have a curved outer surface that extend from the leading edge of the fairing to the tailing edge of the fairing. These curved fairings change the airflow about the end of the trailer to reduce dragging force. Although capable of reducing some dragging force at the end of the trailer, additional fairing designs that can stabilize the airflow wake structure behind the trailer are desirable. As such, there remains room for variation and improvement within the art.

Furthermore, the existing top fairings present problems in relation with rain management. The shape of the existing top fairings prevents water to travel along the top surface of the trailers, to reach the rain gutters located at the rear edge of the top surface of the trailers for the rain to be drained without being projected to following vehicles. Therefore, nowadays, owners must select between in improvement to the drag of the trailer trough a top fairing or having a rain gutter for managing water on top of the trailer. There is therefore need for improvement with that respect.

Furthermore, with the presence of trailers having corrugations on the side, there is a need for an improvement in the side fairings being able to better marry the side surface and guide air along the side surface of the trailer toward the rear of the trailer, and that without a portion of the air getting under the side fairings, or having complicated solution in term of installation or of construction of the side fairings.

There is therefore a need for improvements in this field, including or not features for rain management.

### SUMMARY

In some aspects, the techniques described herein relate to a top fairing for a trailer including: a surface for guiding air thereover, including a flange; a leading surface having a leading radius, the leading surface being joined to the flange and extending in a rearward direction; and a tailing surface having a tailing radius, the tailing surface in continuity to the leading surface in the rearward direction; and openings disposed in the flange for managing water through the flange.

In some aspects, the techniques described herein relate to a top fairing, wherein the flange and the leading surface are joining each other with a root angle of between 8 degrees and 16 degrees.

In some aspects, the techniques described herein relate to a top fairing, wherein the flange is a serrated flange.

In some aspects, the techniques described herein relate to a top fairing, wherein the flange has a depth perpendicular to its longitudinal orientation, and wherein the openings have funnel-shape walls extending through full depth of the flange.

In some aspects, the techniques described herein relate to a top fairing, wherein the openings extend into the leading surface.

In some aspects, the techniques described herein relate to a top fairing, wherein flange has a thickness, and the openings have a height greater than the flange.

In some aspects, the techniques described herein relate to a top fairing, wherein the tailing surface includes a cantilever portion.

In some aspects, the techniques described herein relate to a top fairing, including a support structure, and wherein the cantilever portion is rearward from the support structure.

In some aspects, the techniques described herein relate to a top fairing, wherein the top fairing includes a bridge portion frontward from the cantilever portion, wherein the bridge portion has clearance under while providing support to the tailing surface.

In some aspects, the techniques described herein relate to a top fairing, further includes side walls including a bar opening and a slot, a bar extending through the side walls, and a pair of brackets to be mounted to a top surface of the trailer, each one of the brackets being adapted to be secured to an extremity of the bar and including a wing interfacing with the slot distant from the bar to secure the top fairing against rotation.

In some aspects, the techniques described herein relate to a top fairing, wherein the brackets are adapted to be secured to corner members of the trailer.

In some aspects, the techniques described herein relate to a top fairing, wherein the bar has a transversal coordinate according to its axis, wherein the top fairing has a chord length measured from a leading edge of the leading surface to a tailing edge of the tailing surface, wherein the leading surface and the tailing surface join with each other at a meeting location, and wherein transversal coordinates of the meeting location and of the bar are within 10% of the chord length from each other.

In some aspects, the techniques described herein relate to a top fairing, wherein the top fairing has a chord measured from a leading edge of the leading surface to a tailing edge of the tailing surface, wherein the leading surface and the tailing surface join with each other at a meeting location, and wherein transversal coordinates of center of curvature of the leading radius, of center of curvature of the tailing radius and of meeting location are within 20% of the chord length from each other.

In some aspects, the techniques described herein relate to trailer with fairing including a fairing adapted to manage water.

In some aspects, the techniques described herein relate to a trailer with fairing, wherein the fairing includes side fairing mounted to side surfaces of the trailer.

In some aspects, the techniques described herein relate to a trailer with fairing, wherein the side surfaces include corrugations, and wherein each one of the side fairings includes a side-fairing flange, a side-fairing leading surface, and notches extending into the side-fairing flange and the side fairing leading surface, wherein the notches provide clearance for the corrugations to fill when the flange abuts the side surface of the trailer.

In some aspects, the techniques described herein relate to a fairing kit for decreasing drag, and a pair of top-fairing brackets adapted to mount the top fairing to a top surface of the trailer.

In some aspects, the techniques described herein relate to a fairing kit, further including side fairings and side-fairing brackets adapted to mount the side fairings to side surfaces of the trailer.

In some aspects, the techniques described herein relate to a fairing kit, wherein the side fairing brackets include a surface-contacting portion adapted to abut the side surfaces, and a fairing-mounting portion adapted for the side fairings to be mounted thereto, wherein the fairing mounting portion is adapted to be distant from the side surfaces.

In some aspects, the techniques described herein relate to a top fairing for a trailer including: a surface for guiding air thereover, including a flange; a leading surface having a leading radius, the leading surface being joined to the flange and extending in a rearward direction with a root angle between the flange and the leading surface of between 8 degrees and 16 degrees; and a tailing surface having a tailing radius, the tailing surface in continuity to the leading surface in the rearward direction, wherein the top fairing includes essentially the flange, the leading surface and the tailing surface in continuity to each according to essentially two radii for guiding air thereover.

Preload on forward portion of fender to ensure pressure on the roof to prevent vibrations and rattles. In some aspects, the techniques described herein relates to the structures of aerodynamic fairings that can be made through extrusion, wherein the aerodynamic fairings may be mounted to a cargo body either on the top as a top fairing or on the side as a side fairing, and wherein the mounted aerodynamic fairing decreases drag over the cargo body resulting from displacement thereof.

In some aspects, the description herein relates to an aerodynamic fairing for a body of a cargo container, including: a top wall providing an airflow leading surface, extending from a leading edge to a tailing edge, in a transversal direction of the aerodynamic fairing, and from a first extremity to a second extremity in a longitudinal direction along a longitudinal axis; a first member extending from the top wall away from the leading airflow surface, the first member providing a bottom wall extending distant to the top wall that provides a mounting surface to abut directly or indirectly against the cargo body, wherein, from where the top wall is joining the first member to the leading edge, the top wall includes a front portion that is cantilevered, and wherein the aerodynamic fairing features a profile according to a plane perpendicular to the longitudinal axis, the profile being substantially constant over most of its length spanning between the first extremity and the second extremity.

In some aspects, the description herein relates to an aerodynamic fairing, wherein, from where the top wall is joining the first member to the tailing edge, the top wall includes a rear portion that is a cantilevered.

In some aspects, the description herein relates to an aerodynamic fairing, wherein the first member is a compound member.

In some aspects, the description herein relates to an aerodynamic fairing, further including a second member that couples the top wall to the first member.

In some aspects, the description herein relates to an aerodynamic fairing, wherein the first member extends perpendicular to the top wall where the first member joins the top wall.

In some aspects, the description herein relates to an aerodynamic fairing, wherein the first member extends oblique to the top wall where the first member joins the top wall.

In some aspects, the description herein relates to an aerodynamic fairing, wherein the first member extends oblique to the mounting surface with at least a portion of the first member that is sloped frontwards, and further including a second member that extends oblique to the mounting surface with at least a section of the second member that is being sloped rearwards.

In some aspects, the description herein relates to an aerodynamic fairing, wherein the mounting surface defines a mounting plane, and wherein the top wall crosses the mounting plane frontwards to the first member.

In some aspects, the description herein relates to an aerodynamic fairing, wherein the top wall has a first average thickness frontwards to the first member, and a second average thickness rearwards to the first member, wherein the first average thickness is smaller than the second average thickness.

In some aspects, the description herein relates to an aerodynamic fairing, wherein the front portion of the top wall is shorter than the rear portion of the top wall.

In some aspects, the description herein relates to an aerodynamic fairing, further including a second member, wherein the bottom wall joins the first member to the second member, thereby defining a closed cell.

In some aspects, the description herein relates to an aerodynamic fairing, wherein the first member and the second member are extending along parallel planes.

In some aspects, the description herein relates to an aerodynamic fairing, further including a second member extending from the top wall, wherein the mounting surface defines a mounting plane, and wherein the leading airflow surface has an apex relative to the mounting surface located between wherein the first member and the second member are joining the top wall.

In some aspects, the description herein relates to an aerodynamic fairing, including a front edge and a rear edge, and wherein the top wall is a unitary body spanning between the front edge, the rear edge, the first extremity and the second extremity.

In some aspects, the description herein relates to an aerodynamic fairing, including a first component and a second component that when secured together form the aerodynamic fairing.

In some aspects, the description herein relates to an aerodynamic fairing, wherein the first component includes at least one channel and the second component includes at least one prong for inserting into the at least one channel to secure the first component to the second component.

In some aspects, the description herein relates to an aerodynamic fairing, further including a filling material adhered to the top wall about the first member.

In some aspects, the description herein relates to an aerodynamic fairing, wherein the aerodynamic fairing is made predominantly of at least one of polymer and of a composite material.

In some aspects, the description herein relates to an aerodynamic fairing, wherein at least one of the top wall and the first member has a thickness of at most 10 mm.

In some aspects, the description herein relates to an aerodynamic fairing, wherein an area of the profile of the aerodynamic fairing delimited within the leading airflow surface, a mounting plane in which extends the mounting surface, and lines perpendicular to the mounting plane joining the mounting plane to the leading airflow surface has a dimension of at about 3000 mm2 and 5000 mm2.

In some aspects, the description herein relates to an aerodynamic fairing assembly to be mounted to a body of a cargo container, including: a) a aerodynamic fairing including: i) a top wall providing an airflow leading surface extending from a leading edge to a tailing edge in a transversal direction, and from a first extremity to a second extremity in a longitudinal direction along a longitudinal axis; and ii) a first member extending from the top wall away from the leading airflow surface, the first member providing a bottom wall extending distant to the top wall that provides a mounting surface to abut directly or indirectly against the cargo body; b) an end bracket for mounting the aerodynamic fairing to the body of the cargo container, the end bracket including: i) a mounting portion for securing to the body of the cargo container; ii) a bordering portion for bordering at least part of the bottom wall of the aerodynamic fairing therebetween and the body of the cargo container; and iii) at least two raised portions abutting the aerodynamic fairing distant to the distant to the first member between the leading edge and the tailing edge.

In some aspects, the description herein relates to an aerodynamic fairing assembly, further including a longitudinal bracket secured to the end bracket.

In some aspects, the description herein relates to an aerodynamic fairing mounted to a body of a cargo container, the aerodynamic fairing including: a top wall providing an airflow leading surface extending from a leading edge to a tailing edge in a transversal direction of the aerodynamic fairing, and from a first extremity to a second extremity in a longitudinal direction of the aerodynamic fairing along a longitudinal axis; a first member extending from the top wall away from the leading airflow surface, the first member providing a bottom wall extending distant to the top wall that provides a mounting surface to abut directly or indirectly against the body of the cargo container, wherein, from where the top wall is joining the first member to the leading edge, the top wall includes a front portion that is a cantilevered and biased to abut against the cargo container, wherein the aerodynamic fairing when mounted to the body of the cargo container, has the bottom wall and the leading edge abutting against the cargo container.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a side view of a trailer with fairings mounted thereto;

FIG. 2, is a rear view of the trailer of FIG. 1;

FIG. 3 is a perspective view of the rear portion of the trailer of FIG. 1;

FIG. 4 is a perspective view of a top fairing with a bracket assembled therewith in accordance with an embodiment;

FIG. 5 is an exploded view of the top fairing of FIG. 4 and alternative brackets and securing components depicted;

FIG. 6 is a perspective view of the rear top portion of a trailer with a top fairing mounted thereto in accordance with an embodiment;

FIG. 7 is a side view of the top fairing of FIG. 6 mounted to the top surface of a trailer comprising a rain gutter;

FIGS. 8 and 9 are perspective views of the during its installation, respectively before being mounted to the sides of the trailer and depicting the bracket being secured to the sides of the trailer;

FIG. 10 is a side view of a top fairing in accordance with an embodiment;

FIG. 11 is a side view of a side fairing in accordance with an embodiment;

FIG. 12 is a cross-section view according to a transversal plane of the side fairing of FIG. 11 mounted to mounting brackets;

FIG. 13 is an exploded perspective view of a side fairing and mounting brackets associated therewith adapted to install the side fairing to a side surface of the trailer in accordance with an embodiment;

FIG. 14 is a perspective view of an embodiment of a side fairing comprising notches, the side fairing being mounted to the side surface of a trailer comprising corrugations;

FIGS. 15 and 16 are respectively a perspective view and a close-up view of a front portion of a top fairing showing a single water inlet in accordance with an embodiment;

FIGS. 17 and 18 are respectively a perspective view and a close-up view of a front portion of a top fairing showing a single water inlet in accordance with another embodiment;

FIGS. 19 and 20 are respectively a perspective view and a close-up view of a front portion of a top fairing showing a single water inlet in accordance with another embodiment;

FIG. 21 is a perspective view a top fairing with another embodiment;

FIG. 22 is a perspective view of a top fairing in accordance with an embodiment;

FIG. 23 is a side view of the top fairing of FIG. 22;

FIG. 24 is a perspective view of a rear portion of trailer, and of a top fairing mounted thereto as a top fairing in accordance with an embodiment;

FIG. 25 is side view of a leading portion of the top fairing of FIG. 22 with automotive double-sided tape applied thereto in accordance with an embodiment;

FIG. 26 is side view of a central portion of the top fairing of FIG. 22 in accordance with an embodiment;

FIG. 27 is side view of a tailing portion of the top fairing of FIG. 22 in accordance with an embodiment;

FIG. 28 is a bottom perspective view of a portion of an extremity the top fairing of FIG. 22 in accordance with an embodiment;

FIG. 29 is a bottom perspective view of a portion of an extremity the top fairing of FIG. 22 with proper double-sided tape applied thereto in accordance with an embodiment;

FIG. 30 is a perspective view of a bracket for mounting a top fairing to a mounting surface of a trailer in accordance with an embodiment;

FIG. 31 is a top view of a portion of the bracket of FIG. 30 in accordance with an embodiment;

FIG. 32 is a perspective view of a portion of a trailer and of an extremity of a top fairing mounted thereto with a bracket in accordance with an embodiment;

FIG. 33 is a side view of a top fairing mounted to a mounting surface using other brackets in accordance with an embodiment;

FIG. 34 is a perspective view of a central portion of an extremity of a top fairing with a bracket mounted thereto ready to be screwed to a mounting surface in accordance with an embodiment;

FIG. 35 is a side view of a top fairing in accordance with an embodiment;

FIG. 36 is a side view of a top fairing in accordance with an embodiment;

FIG. 37 is a side view of a top fairing mounted to a trailer in accordance with an embodiment;

FIG. 38 is a side view of a top fairing with an open cell in accordance with an embodiment;

FIG. 39 is a closeup side view of the leading end of the top fairing of FIG. 36 according to identification-39-in FIG. 36;

FIG. 40 is a side view of a top fairing in accordance with an embodiment;

FIG. 41 is a side view of a top fairing with a single compound member in accordance with an embodiment;

FIG. 42 is a side view of a top fairing with open cells in accordance with an embodiment;

FIG. 43 is a side view of a two-piece top fairing in accordance with an embodiment;

FIG. 44 is a side view of a two-piece top fairing in accordance with an embodiment;

FIG. 45 is a side view of three-piece top fairing in accordance with an embodiment;

FIG. 46 is a side view of a top fairing with cells embedded in the top wall in accordance with an embodiment;

FIG. 47 is a top perspective exploded view of a top fairing and brackets used to mount the top fairing to a trailer in accordance with an embodiment;

FIG. 48 is a bottom perspective view of a top fairing and brackets used to mount the top fairing to a trailer in accordance with an embodiment;

FIG. 49 is a side view of the top fairing and the end bracket of FIG. 48;

FIG. 49A is a close-up side view of the top fairing and the end bracket of FIG. 49;

FIG. 50 is a perspective bottom view of a top fairing adapted to be mounted using liquid adhesive in accordance with an embodiment;

FIG. 51 is a perspective bottom view of a top fairing and an end bracket adapted to be mounted using liquid adhesive in accordance with an embodiment;

FIG. 52 is a perspective view of a trailer with a top fairing mounted thereto with brackets in accordance with an embodiment;

FIG. 53 is a close-up perspective view of the trailer, the top fairing and the end bracket depicted on FIG. 52;

FIG. 54 is a perspective partially exploded view of a portion of a top fairing mounted to a trailer and a cap closing openings of the top fairing in accordance with an embodiment;

FIG. 55 is a perspective partially exploded view of a portion of a top fairing mounted to a trailer and caps closing top openings of the top fairing in accordance with an embodiment;

FIG. 56 is a side view of a top fairing mounted to a side rail of a trailer with a bracket in accordance with an embodiment;

FIG. 57 is a cross-section side view of a top fairing in accordance with an embodiment;

FIG. 58 is a side view of a top fairing with no filling material in accordance with an embodiment;

FIG. 59 is a side view of the top fairing of FIG. 58 with filling material;

FIG. 60 is a side view of another top fairing with filling material in accordance with an embodiment; and

FIG. 61 is a side view of the top fairing of FIG. 60 with filling material.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as,” or the like) provided herein, is intended merely to better illuminate the exemplary realizations and does not pose a limitation on the scope of the realizations. No language in the specification should be construed as indicating any unclaimed element as essential to the practice of the realizations.

In the following description, it is understood that terms such as “first”, “second”, “top”, “bottom”, “above”, “below”, and the like, are words of convenience and are not to be construed as limiting terms.

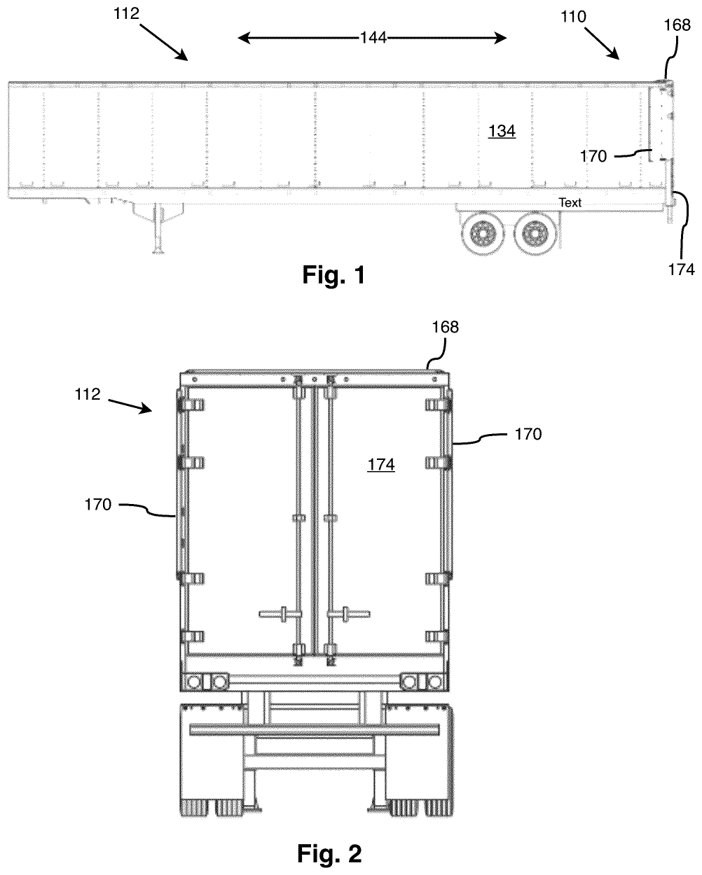

The terms “top”, “up”. “upper”. “bottom”, “lower”, “down”, “vertical”, “horizontal”, “interior” and “exterior” and the like are intended to be construed in their normal meaning in relation with normal installation of the product, with normal orientation of the components being depicted on FIG. 1.

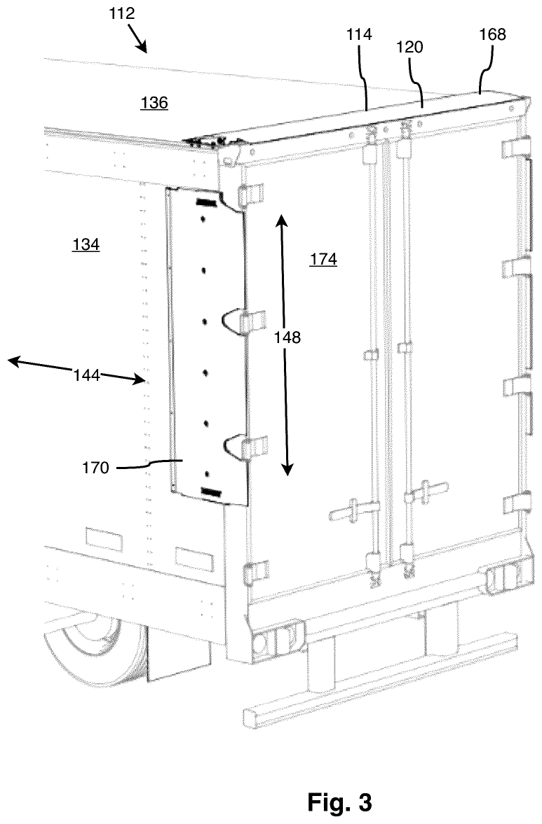

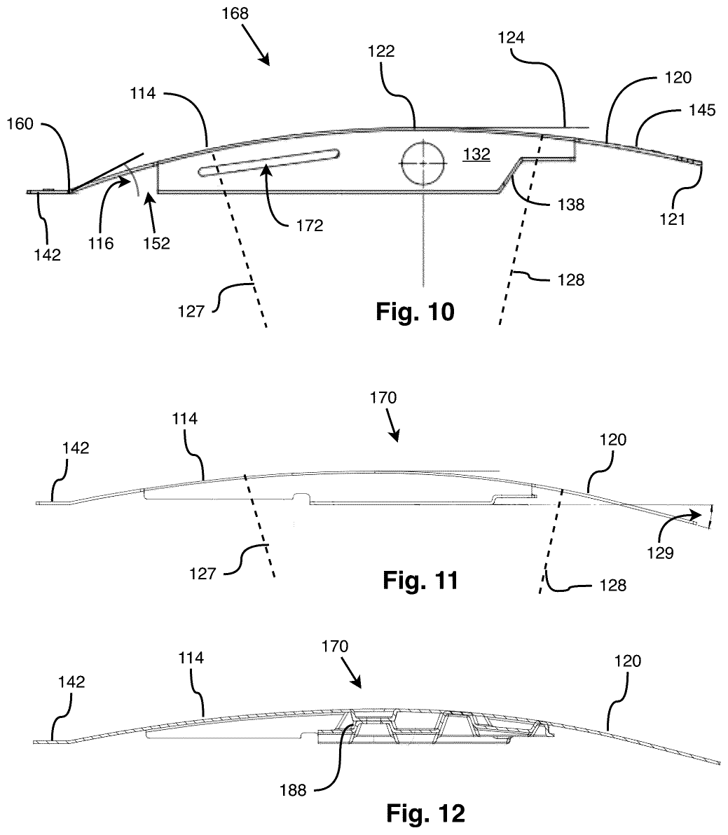

Referring to FIGS. 1 to 3, the present invention provides for a fairing 110 a back of the trailer 112 that improves aerodynamic performance of the trailer 112 to reduce drag on the trailer 112 when a truck (not depicted, located at the front of the trailer) is hauling the trailer 112. The fairing 110 comprises a top fairing 168 that is attached to the top surface 136 of the trailer 112, or the fairing 110 may be a side fairing 170 attached to the side surface 134 of the trailer 112. Typically, the trailer 112 is provided with side fairings 170 on both of its side surfaces 134, and with a top fairing 168 on its top surface 136. The fairing 110 features a leading airflow surface 114 that has a leading radius. The leading airflow surface 114 meets a tailing airflow surface 120 at a meeting location 122 (see FIG. 10), and a common tangent line 124 (see FIG. 10) extends through the meeting location 122 and is tangent to both the leading airflow surface 114 and the tailing airflow surface 120 at this point. The fairing 110 is designed for the air to travel over the leading airflow surface 114 and to follow the tailing airflow surface 120 to result in an optimal reduction of drag on resulting from air led to the rear of the trailer 112 during transport.

FIGS. 1 to 3 illustrate a trailer 112 adapted to be hauled by a truck that features at its rear portion fairings 110 in accordance with an exemplary embodiment. The combination of the truck and trailer 112 extends in a longitudinal direction 144 which is the general direction of travel as the truck hauls the trailer 112 forward. The fairings 110 are designed to deflect airflow in an optimal manner around the back of the trailer 112 so that drag on the trailer 112 during travel is optimally reduced. The geometric design of the fairing 110 includes features that result in this optimal reduction of drag. Although three fairings 110 are shown at the back end of the trailer 112, it is to be understood that the trailer 112 may be outfitted with only one or with two of the fairings 110 in other exemplary embodiments. The fairings 110 are preferably located proximate to the terminal end 174 of the trailer 112, secured to the trailer 112, and are forward of the terminal end 174 in the longitudinal direction 144. In some instances, the fairings 110 may extend rearward of the terminal end 174 in the longitudinal direction 144. The fairings 110 are located near the terminal end 174 of the trailer 112 because they are designed to affect the flow of air at the back end of the trailer 112 and behind the trailer 112 during travel. Additional fairings (not shown), not specifically discussed herein, can be employed e.g., at the bottom of the trailer 112 or in other locations on the trailer 112 as desired for combined effect on drag of the trailer 112.

### Top Fairing

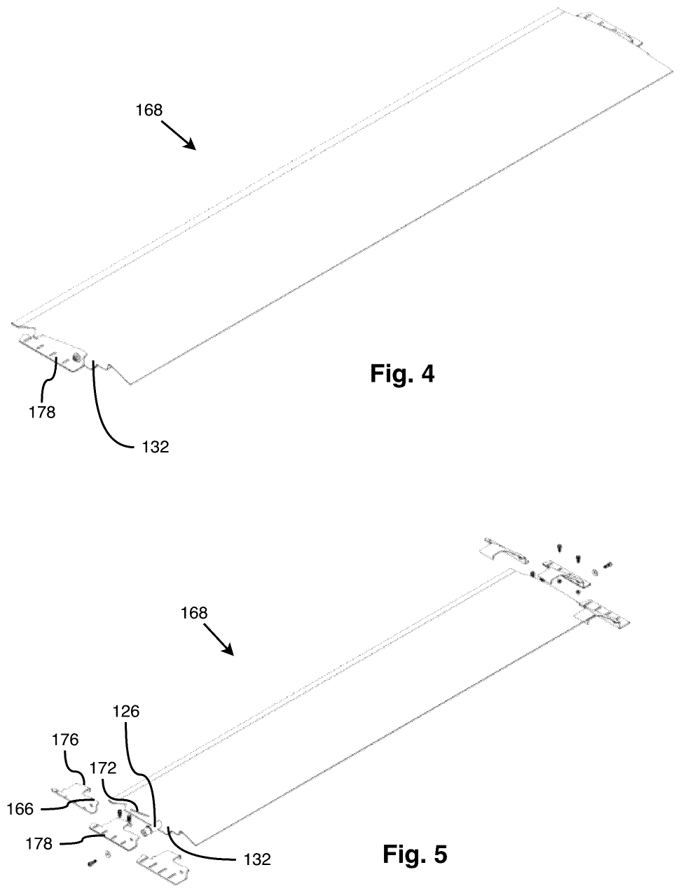

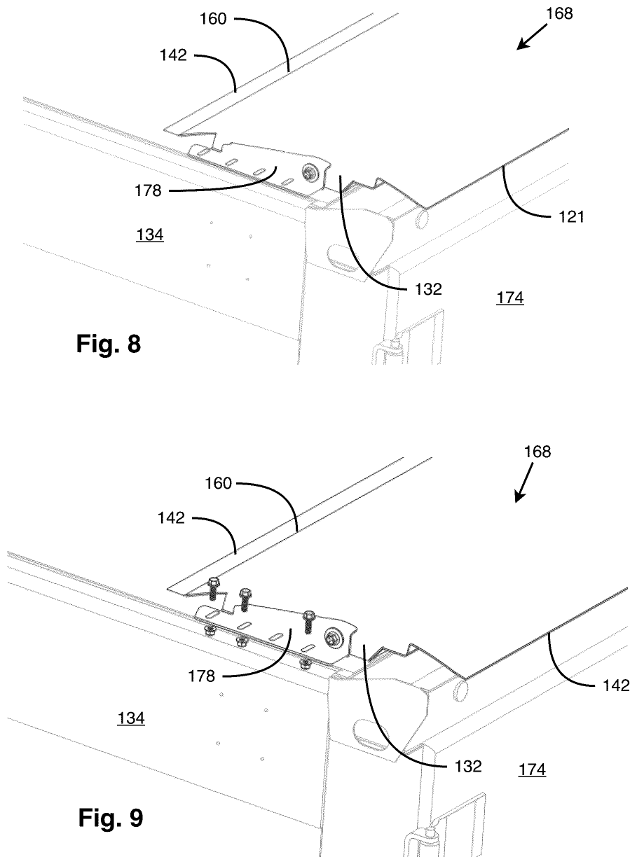

With additional reference to FIGS. 4 to 10, the top fairing 168 is located at the back end of the trailer 112 so that it is closer to the back terminal end 174 of the trailer 112 than to the front terminal end of the trailer 112. The top fairing 168 may be spaced some amount forward of the back terminal end 174 in the longitudinal direction 144, may terminate right at the back terminal end 174, or may extend slightly rearward from the back terminal end 174 in the longitudinal direction 144. The top fairing 168 extends almost all the way across the top surface 136 in the lateral direction 146 of the trailer 112 so as to extend about both the right and left side surfaces 134.

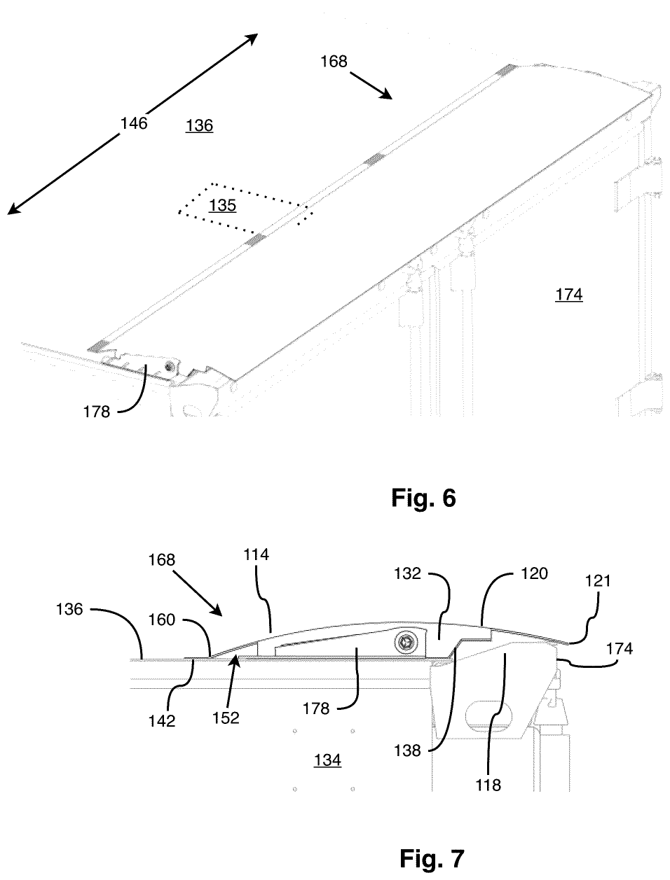

FIG. 7 is a side view of the back end of the trailer 112 with the top fairing 168 positioned onto the top surface 136 of the trailer 112. The top fairing 168 has a leading airflow surface 114 that is forward of a tailing airflow surface 120 in the longitudinal direction 144. The top fairing 168 is typically made of an unibody component mounted to the top surface 136 secured with fixing components to the top surface 136. The leading airflow surface 114 and the tailing airflow surface 120 may be constant or may vary along the width of the top fairing 168. In other words, the leading airflow surface 114 and the tailing airflow surface 120 may be measured according to longitudinal planes (e.g., plane 135, FIG. 6) characterized by their transversal coordinate relative to a reference, e.g., the side edge of the trailer 112. The leading airflow surface 114 and the tailing airflow surface 120 may be constant or vary as they are measured at different transversal coordinates. As such, it is to be understood, as used herein, that the leading airflow surface 114 and the tailing airflow surface 120 discussed herein may be measured according to any transversal coordinate over the width of the top fairing 168. It is further to be understood that as used herein, when discussing the orientation of the surfaces 114, 120 with respect to angles, radii, locations, ranges, etc. the portion of the surfaces 114, 120 that are being measured or discussed are the outer surfaces of the leading airflow surface 114 and the tailing airflow surface 120 and not interior portions, if any, of these surfaces 114, 120. The surfaces 114, 120 can be made of plastic and may be manufactured according to a first embodiment through a thermal plastic forming process, or according to another embodiment made of extruded plastic, the latter being characterized in constant characteristics of the surfaces 114, 120 over the width of the top fairing 168.

The leading airflow surface 114 has a leading edge 160 that is the forward most portion of the leading airflow surface 114 in the longitudinal direction 144. Forward of the leading edge 160 is an anchoring flange 142. The leading airflow surface 114 is oriented, from the anchoring flange 142 parallel to the top surface 136, with a root angle 116 that is typically from 8 to 16 degrees, and more preferably from 12 to 16 degrees, and preferably about 14.4 degrees. The root angle 116 is oriented rearward in the longitudinal direction 144. The root angle 116 is measured relative to the top surface of the anchoring flange 142, itself parallel to the side surface 134. In this regard, an angle of zero (0) degree refer to a surface parallel to the top surface 136, and a root angle 116 that is of one- hundred and eighty (180) degrees refers to a leading airflow surface 114 that would be normal to the top surface 136 at the leading edge 160. The leading airflow surface 114 is curved at a set amount so that the entire leading airflow surface 114 has a single leading radius 127. The leading radius 127 is in the range from 500 millimeters to 900 millimeters. In more preferred embodiments, the leading radius 127 is from 700 millimeters to 800 millimeters, and preferably about 760 millimeters.

The leading airflow surface 114 ends at a meeting location 122 where it meets the tailing airflow surface 120. The tailing airflow surface 120 is a curved surface that extends from the meeting location 122 to a tailing edge 121. The tailing edge 121 is about or rearward to the terminal end 174 in the longitudinal direction 144. In the embodiment shown, the tailing airflow surface 120 is curved at a set amount so that the entire tailing airflow surface 120 has a single tailing radius 128. The tailing radius 128 is in the range from 500 millimeters to 1800 millimeters. In more preferred embodiments, the tailing radius 128 is from 800 millimeters to 1600 millimeters, and preferably about 900 millimeters.

The leading airflow surface 114 and the tailing airflow surface 120 are oriented with respect to one another so that they share a common tangent line 124 that is about the apex (i.e., within the top 5% of the height of the top fairing 168, and preferably within 2.5% of its height) and about the center (i.e. within the range of 30% to 70% of the transversal length 145 measured from the leading edge 160 to the tailing edge 121, and preferably within the 40% to 60% of the transversal length 145). The meeting location 122 is the point of engagement between the leading airflow surface 114 and the tailing airflow surface 120 and in so far as the common tangent line 124 is common to both of these surfaces 114, 120. This arrangement affords airflow off of the leading airflow surface 114 to channel against the tailing airflow surface 120 with no disruption. The orientation and leading radius 127 of the leading airflow surface 114 and of the tailing airflow surface 120 results in a geometry of the top fairing 168 that causes an air flow to travel downward over the top fairing 168 around the rear of the trailer 112 to reduce dragging force while the truck is hauling the trailer 112 to improve its fuel efficiency.

The leading air flow surface 114 is spaced from the top surface 136 so that a gap 152 is present and the portion of the top fairing 168 that is below the leading air flow surface 114 is not in engagement with the top surface 136.

The anchoring flange 142 is attached, typically glued with double-face automotive tape, to the top surface 136. According to an embodiment, the anchoring flange 142 is glued over the width of the anchoring flange 142 (from about one side edge to about the other side edge of the top surface 136) with sections of double-sided tape spaced with sections free of tape; the latter providing a gap of the thickness of the double-sided tape for water to flow toward a rain gutter at the rear end of the top surface 136 of the trailer 112.

The installation of the top fairing 168 involves a bar 126 that extends between the top surface 136 and the surfaces 114, 120, and that extends sideways between the side wall 132 of the top fairing 168 to be secured to a mounting bracket 178 at both ends. The bar 126 can extend over the whole width of the top fairing 168, and can be secured to the top fairing 168 at locations to reinforce the top fairing against deformation and/or vibration. The bar 126 can be a separate component from the top fairing 168, or may be permanently assembled to the surfaces 114, 120.

It is to be understood that the bar 126 can be a component that is separate from the leading airflow surface 114 and the tailing airflow surface 120, The bar 126 may be alternatively integral to the top fairing 168. The bar 126 may be a single bar. The bar 126 may alternatively be made of a plurality of bar sections, either or not joined to each other. The bar 126 may be made of the same material than the portion of the top fairing 168 defining the leading airflow surface 114 and the tailing airflow surface 120. The bar 126 may alternatively be made or of a different material than the surfaces 114, 120. Typically, the bar 126 presents more rigidity than the surface 114, 120.

The bar 126 is shown attached to the top surface 136 through the brackets 178 secured to the top of the trailer 112 on opposite sides in the lateral direction 146 (depicted on FIG. 6), and more precisely close enough to the side edges of the trailer 112 to have the bolts securing the brackets 178 to the trailer 112 not penetrating in the interior compartment of the trailer 112. The bar 126 is secured to brackets 178, and an interface between an extending wing 176 and a slot 172 present in the side walls 132 exerts the anchoring flange 142 downward. A top wing 166 of the brackets 178, presenting itself as an inward folding of a top portion of the brackets 178, complete the interface of the top fairing 168 with the brackets 178. The top wings 166 participate in preventing rotation of the top fairing 168. The described mounting of the top fairing 168 provides some side clearance for transversal adjustment of the top fairing 168. Accordingly, a single bar 126 provides the required strength to attach the top fairing 168 to the top surface 136.

As discussed, the use of the bar 126 allows the side walls 132, and consequently the leading airflow surface 114 and the tailing airflow surface 120, to be secured to the trailer 112 without having to drill holes through the top surface 136, which could result in rain or contaminants entering the compartment of the trailer 112. In this manner, the compartment of the trailer 112 is made more secure by the use of the side-mounted brackets 178 and the bar 126 to retain the top fairing 168 to the trailer 112. Although described as utilizing a single tubular bar 126 to secure the top fairing 168, which provides advantages over alternatives, more than one bar or a bar of another shape may be used in other embodiments.

According to realizations, the tailing air flow surface 120 is adapted for a cantilevered portion to cover a rain gutter located at the rear end of the top surface 136. The tailing airflow surface 120 may be adjusted to adapt rain gutters of different dimensions.

The side walls 132 have a rear edge 138 distant from the tailing edge 121. The rear edge 138 defines a clearance under a cantilevered portion of the tailing surface 120 allowing the top fairing 168 to adapt to top surfaces having no rain gutter and rain gutters 118 of different dimensions, whereby mounting the brackets 178, thus the top fairing 168, farther (for a top surface 136 featuring no rain gutter) or closer (for a top surface 136 featuring a rain gutter 118 of up to e.g., 1⅜ inches to have the tailing edge 121 above the rain gutter 118 and reaching the terminal end 174.

According to an embodiment, the rear edge 138 features an upward-rearward slop followed in the direction of the tailing edge 121 by a rearward portion. This shape is adapted to improve clearance while limiting the cantilevered portion of the tailing airflow surface 120 to an acceptable value.

According to a preferred realization, the tailing airflow surface 120 may be marked with indications (not depicted) where to cut the tailing airflow surface 120 based on the dimension of the rain gutter 118 to adapt to.

According to a preferred realization, the meeting location 122, where uplift forces are at their maximum, is within 10% of the total chord 145 from the leading edge 160 to the tailing edge 121 relative to the position in the longitudinal direction of the center of the bar 126. More preferably, it is within 5% relative to the position in the longitudinal direction of the center of the bar 126.

The profile of the top fairing 168 may be defined by the parameters of the leading airflow surface 114 and the tailing airflow surface 120, including the root angle, characteristics of their meeting, etc. According to a preferred realization, the root angle 116 is between 8 and 16 degrees, and more preferably between 12 and 16 degrees, and preferably about 14.4 degrees. The leading radius 127 is in the range from 500 millimeters to 1800 millimeters. In more preferred embodiments, the leading radius 127 is from 500 to 900 millimeters, and preferably from 700 millimeters to 800 millimeters, and preferably about 760 millimeters. The tailing radius 128 is in the same ranges than the leading radius, and preferably about 900 millimeters. The center of curvature of the leading radius 127 is located under the surfaces 114, 120 and its longitudinal coordinate is within 20% of the chord 145 relative to the meeting location 122, and preferably within 10% of the chord 145 relative to the longitudinal coordinate of the meeting location 122. The center of curvature of the tailing radius 128 is located under the surfaces 114, 120 and its longitudinal coordinate is within 20% of the chord 145 relative to the meeting location 122, and preferably within 10% of the chord 145 relative to the longitudinal coordinate of the meeting location 122. The tailing angle 129 (see FIG. 12 for depiction on the side fairing 170) is between 10 and 30 degrees, and preferably more than 10 degrees, and more preferably more than 12 degrees.

According to another perspective, the ratio of the leading radius 127 over the tailing radius 128 is between 2 over 1 and 1 over 2, preferably between 3 over 2 and 2 over 3, preferably between 4 over 5 and 5 over 4, and preferably about 5 over 6.

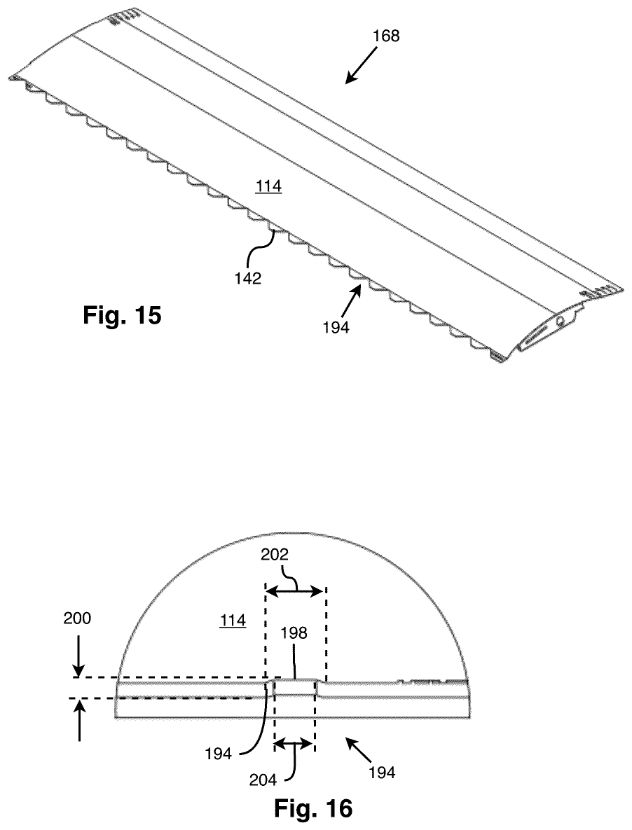

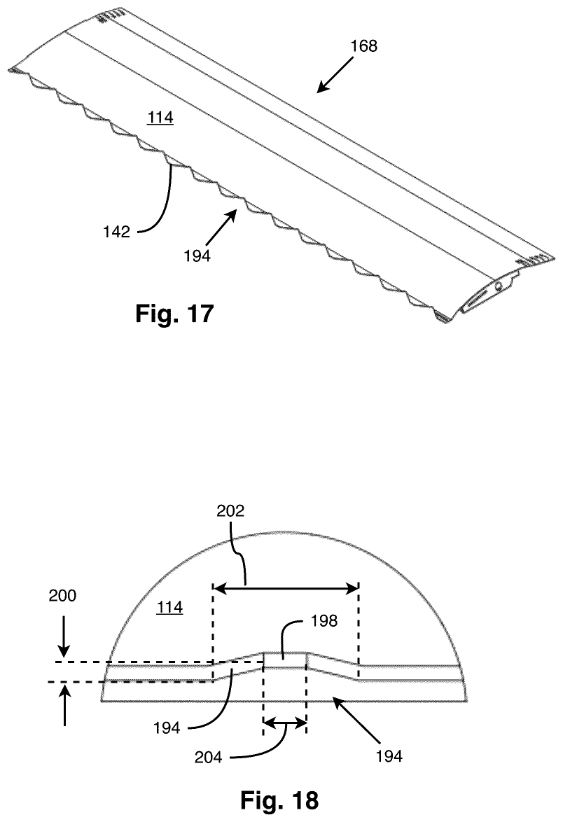

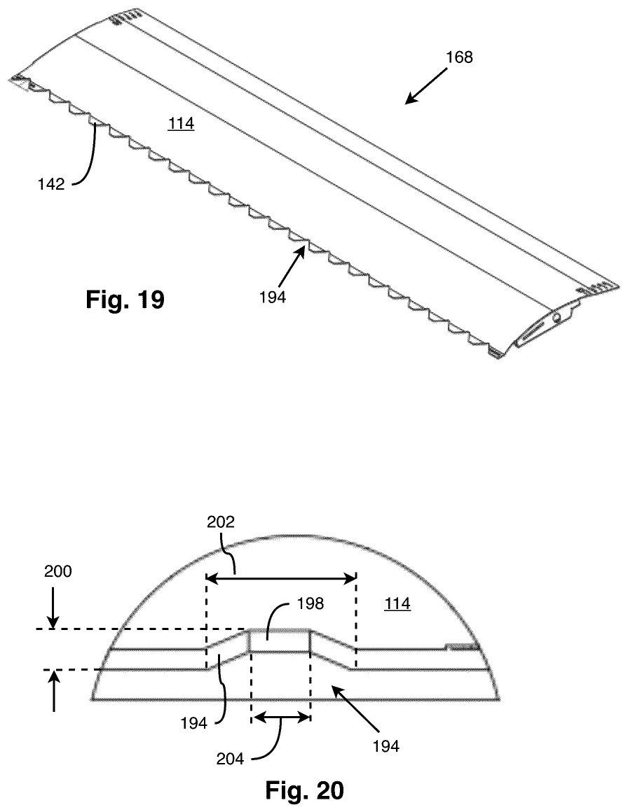

Referring now to FIGS. 15 to 21, according to embodiments, top fairings 168 feature an improved water management feature comprising a series of water inlets 194 having a generally funnel-shaped aperture on the anchoring flange 142 extending over the whole depth of the anchoring flange 142 and ending with a e.g., curved opening 198 at the root of the leading airflow surface 114, wherein the opening 198 has small height 200 and an inlet width 204 providing passage for big water drops to travel from in front of the anchoring flange 142 to under the top fairing 168 and finally reaching e.g., a rain gutter. Accordingly, water falling over the top surface 136, instead of accumulating in front of the anchoring flange 142, and travelling over the top fairing 168 and risking falling from the tailing edge 121 at the rear of the trailer 112 on following vehicles, are drained through the rain gutter 118 (see for example FIG. 7).

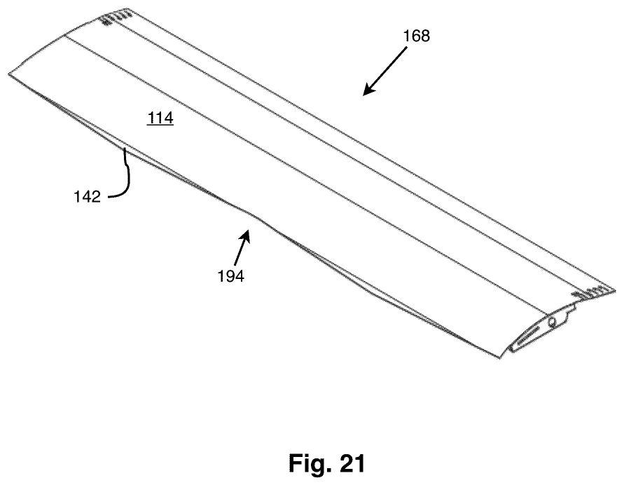

Embodiments includes top fairings 168 featuring from 3 water inlets 194 (FIG. 21) including two partial water inlets on the sides and a central one, and to more than 30 water inlets 194. According to embodiments, the height 200 of the aperture may vary from about the thickness of the anchoring flange 142 to up to three times the thickness of the anchoring flange 142 with low influence on drag reduction resulting from the use of the top fairing 168. The present disclosure contemplates different shapes (e.g., straight, curved) and width 202 of side walls 194 for the funnel-shaped apertures and spacing between the side walls 194 of neighbor water inlets 194 being null to a ratio of e.g., four time the width 202. The present disclosure further contemplates general shapes of the opening 198 from being either straight or having a curved shape, or another shape appropriate in relation with the material in which the top fairing 168 is made of.

### Side Fairing

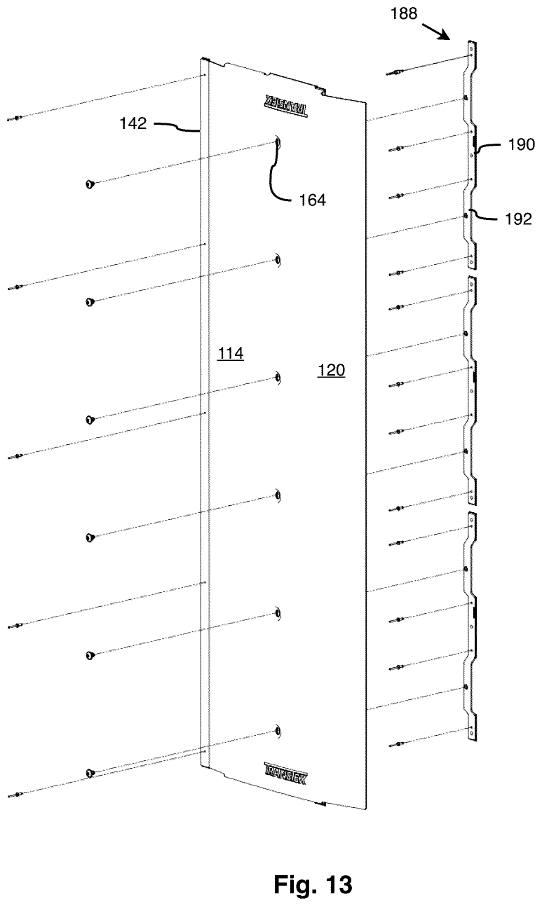

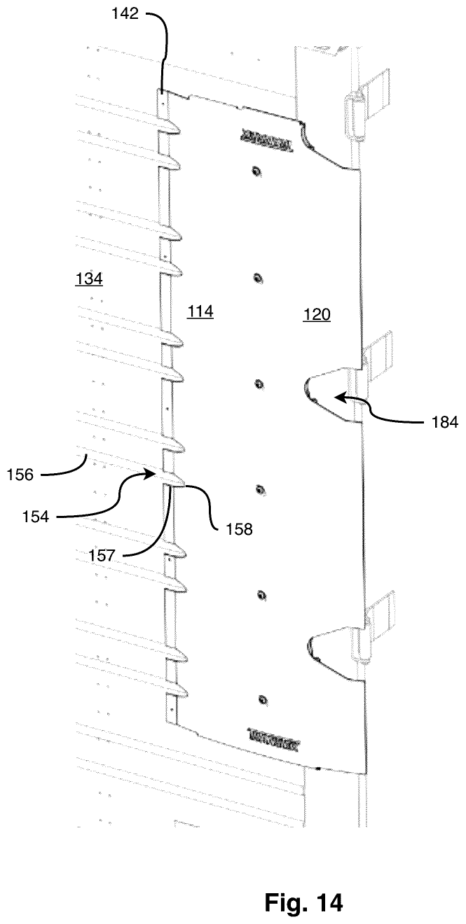

Referring now to FIGS. 1 to 3 and 11 to 14, the side fairing 170 extends in a vertical direction 148 of the trailer 112 along some, but typically not all, of the vertical height of the trailer 112. The side fairing 170 is typically located closer to the top surface 136 of the trailer 112 than a bottom surface of the trailer 112. The side fairing 170 may be located at the top surface 136, or it may be spaced some distance from the top surface 136 in the vertical direction 148. The side fairing 170 is mounted to the side surface 134 of the trailer 112.

According to an embodiment, the side fairing 170, which function is to direct the flow of air around the side of the trailer 112 and to an area behind the trailer 112 to result in less drag on the trailer 112 when the trailer 112 is hauled by a truck, has an anchoring flange 142 attached to the side surface 134, and a leading airflow surface 114 that joins the anchoring flange 142 farther in the longitudinal direction 144, and a tailing airflow surface 120 that follows the leading airflow surface 114 in the longitudinal direction 144.

In some instances, the side surface 134 of the trailer 112 can include corrugations 156 that extend in horizontally in the longitudinal direction 144. The side fairing 170 may be provided with notches 154 having an ogive-like shape having a pair of parallel edges 157 at the anchoring flange 142 leading to a curved apex 158 distant to the anchoring flange 142. The notches 154 are adapted for the corrugations 156 to be disposed therein in order to allow the anchoring flange 142 of the side fairing 170 to marry the flat portion of the side surface 134 between the corrugations 156.

The side fairing 170 has a leading airflow surface 114 and a tailing airflow surface 120 that have similar characteristics than the ones of the top fairing 168.

According to an embodiment, the radii 127, 128 of the side fairing 170 are respectively of about 1450 millimeters and of about 900 millimeters.

According to an embodiment, the side fairing 170 is secured to the side surface 134 using a series of mounting brackets 188 having surface-contacting portions 190 and fairing-mounting portions 192 spaced from the side surface 134 such as adapted to provide clearance for corrugations 156 and mounting screw tips. The mounting brackets 188 are adapted for the surface-contacting portions 190 to be secured to the side surface 134 with tape and/or rivets. The side fairing 170 is secured to the fairing-mounting portions 192 with screws.

According to a preferred embodiment, the side fairing 170 features recesses 164 for the head of the screw to not extend, or extend only slightly, over its outer surface 114 or 120.

According to embodiment, the side fairings 170 may be mounted to extend beyond the terminal end 174 of the trailer 112. In some embodiments, hinge notches 184 (of similar shape to the corrugation notches 154) are present to provide clearance for hinges when opening the doors of the trailer 112 without the hinges flexing the side fairings 170.

In is to be noted that the design of the top fairing 168 and the side fairing 170 may differ in that their root angle and their radii. However, it is preferred that profiles for the top fairing 168 and the side fairing 170 remain with the ranges listed herein.

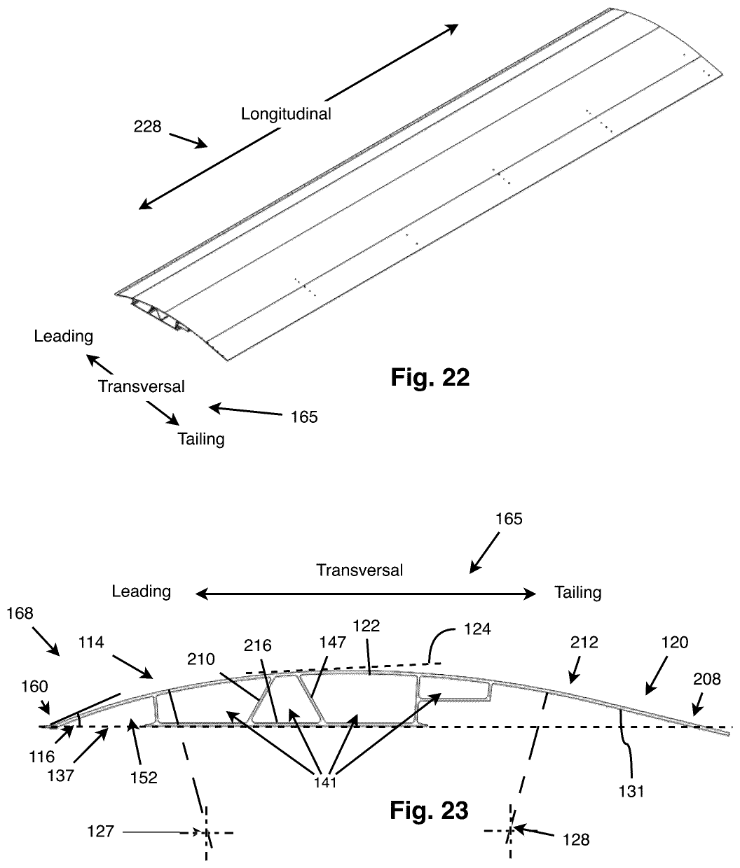

Referring now to FIG. 22 and FIG. 23, the top fairing 168 of an embodiment features a leading airflow surface 114 that has a leading radius 127. The leading airflow surface 114 meets a tailing airflow surface 120 at a meeting location 122, and a common tangent line 124 that extends through the meeting location 122 that is tangent to both the leading airflow surface 114 and the tailing airflow surface 120. The top fairings 168 are designed for the air to be deflected thereby, the air travelling over the leading airflow surface 114 and following the tailing airflow surface 120 to result in a reduction of drag on the rear of the trailer 112, or more generally a cargo body or body of a cargo container, during transport.

Referring additionally to FIGS. 1 to 3 where is illustrated a trailer 112 adapted to be hauled by a truck that features aerodynamic fairings 110 close to the terminal end 174 of the trailer 112 in accordance with an exemplary embodiment. The combination of the truck and trailer 112 extends in a longitudinal direction 144 which is the general direction of travel as the truck hauls the trailer 112 forward. The aerodynamic fairings 110 are designed to deflect airflow in an optimal manner for a reference speed, the airflow being deflected about the back of the trailer 112 so that drag on the trailer 112 during travel is optimally reduced at the reference speed while providing substantial reduction of drag when traveling at neighbor speeds. The geometric design of the fairing 168 includes features that result in this optimal reduction of drag. Although three aerodynamic fairings 110, namely top fairing 168 and side fairings 170, are shown at the back end of the trailer 112, it is to be understood that the trailer 112 may be outfitted with only the top fairing 110 or the side fairings 170 in other exemplary embodiments. The aerodynamic fairings 110 are preferably located proximate to the terminal end 174 of the trailer 112, secured to the trailer 112, and mounted either forward to the terminal end 174 in the longitudinal direction 144 or slightly extending rearward to the terminal end 174 of the trailer 112. Additional fairings (not shown), of the same nature or of a different nature, not specifically discussed herein, can be combined thereto, mounted e.g., at the bottom of the trailer 112 or in upstream locations on the trailer 112 for combined effect of reduction of drag of the trailer 112.

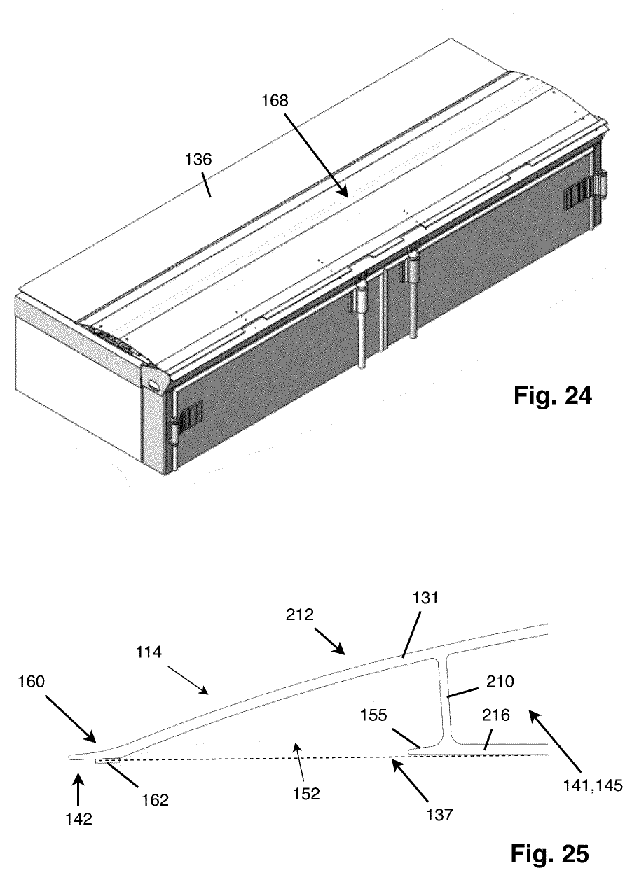

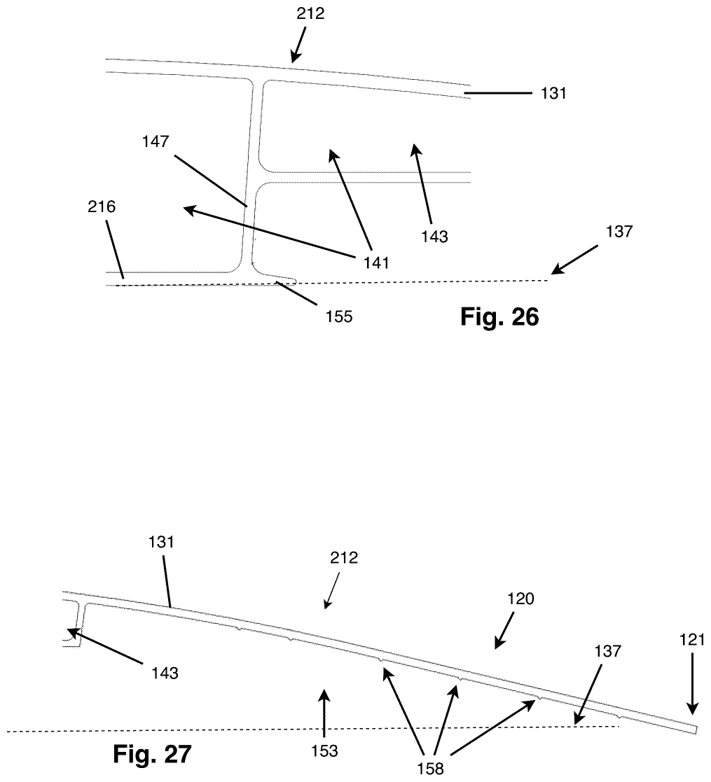

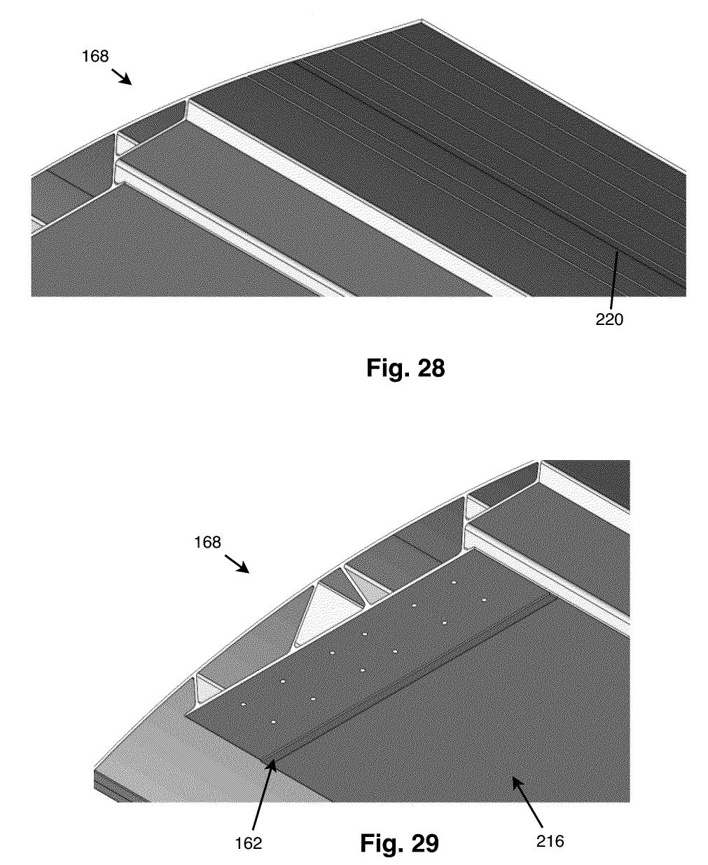

Referring back to FIG. 22, FIG. 23, and referring further to FIG. 24, FIG. 25, FIG. 26, FIG. 27 and FIG. 28, top fairing 168 comprises a top wall 131 providing an airflow surface 212 along which the air flows, the airflow surface 212 comprising a leading airflow surface 114 that is forward of a tailing airflow surface 120 in the transversal direction 165 of the top fairing 168. According to an embodiment, the top fairing 168 is made of extruded material providing a regular, preferably invariant, profile in its longitudinal direction comprising in an embodiment a series of closed cells 141 adapted to provide structure and to mount the top fairing 168 to a mounting surface 136 of the trailer 112.

It is worth noting that the top fairing 168, once manufactured, may be cut for installation, e.g., cut to the appropriate length, and be customized for a particular use, e.g., notches may be cut in the tailing portion of the top wall 131 for providing clearance for e.g., rails and door locking mechanisms.

According to a preferred embodiment, the top fairing 168 is preferably sized to cover the whole width of the trailer 112 when installed on the top of the trailer 112. When compared to existing fairings, the present top fairing 168 spread over a wider proportion of the trailer 112, improving the drag reduction effect thereof.

In a typical embodiment, the leading airflow surface 114 of the top fairing 168 has a leading edge 160 that is the frontmost portion of the leading airflow surface 114 in the transversal direction 165 of the top fairing 168, and thus the longitudinal direction 144 of the trailer, once mounted thereto. Forward of the leading edge 160 is a front flange 142 adapted to marry the surface of the trailer 112 to which it is mounted. The leading airflow surface 114 is oriented, from the front flange 142 parallel to the top surface 136, with a root angle 116 that is typically from 8 to 16 degrees, and more preferably from 12 to 16 degrees, and preferably about 14.4 degrees. The root angle 116 is oriented rearward in the longitudinal direction 144. The root angle 116 is measured relative to the top surface of the front flange 142, itself parallel to the mounting surface 136. In this regard, an angle of zero (0) degree refer to a surface parallel to the mounting surface 136 to which is mounted the top fairing 168. The leading airflow surface 114 is curved at a set degree so that the entire leading airflow surface 114 has a single leading radius 127. The leading radius 127 is in the range from 500 millimeters to 900 millimeters. In more preferred embodiments, the leading radius 127 is from 700 millimeters to 800 millimeters, and preferably about 760 millimeters.

The leading airflow surface 114 ends at a meeting location 122 where it meets the tailing airflow surface 120. The tailing airflow surface 120 is a curved surface that extends from the meeting location 122 to a tailing edge 121, in other words aft edge, or at the aft end of the top fairing 168. In an embodiment, the tailing edge 121 is designed to be mounted about or rearward to the terminal end 174 of the trailer 112. In the embodiment shown, the tailing airflow surface 120 is curved at a set amount so that the entire tailing airflow surface 120 has a single tailing radius 128. The tailing radius 128 is in a range between 500 millimeters and 1800 millimeters. In more preferred embodiments, the tailing radius 128 is in a range between 800 millimeters and 1600 millimeters, and preferably about 900 millimeters.

The leading airflow surface 114 and the tailing airflow surface 120 are oriented with respect to one another so that they share a common tangent line 124 that is about the apex, e.g., within the top 5% of the height of the top fairing 168 when mounted to a mounting surface 136, and preferably within the top 2.5% of the height of the top fairing 168, and about the center, e.g., in a range between 30% to 70% of a reference chord 208 measured following the airflow surface 212 from the leading edge 160 to the tailing edge 121 according to a point of the leading edge 160 and the tailing edge 121 intersected by the straight line 137 corresponding to the mounting surface 136 when mounted thereto, and preferably in a range of between 40% to 60% of the reference chord 208. The meeting location 122 is the point of engagement between the leading airflow surface 114 and the tailing airflow surface 120. This arrangement affords airflow off from the leading airflow surface 114 to channel against the tailing airflow surface 120 with no disruption. The orientation and leading radius 127 of the leading airflow surface 114 and of the tailing airflow surface 120 results in a geometry of the airflow surface of the top fairing 168 that causes an airflow to travel toward the space rearward to the terminal end 174 over the top fairing 168 and thereby reduce dragging force while the truck is hauling the trailer 112, and in consequence improving its fuel efficiency.

In a realization, the front flange 142 extends a little lower than the straight line 137 before installation (see relaxed front flange in e.g., FIG. 44), thereby for the installation on the top surface 136 applying a downward force preloading the leading edge 142 to minimize the ingress of air and vibration over the mounting surface 136.

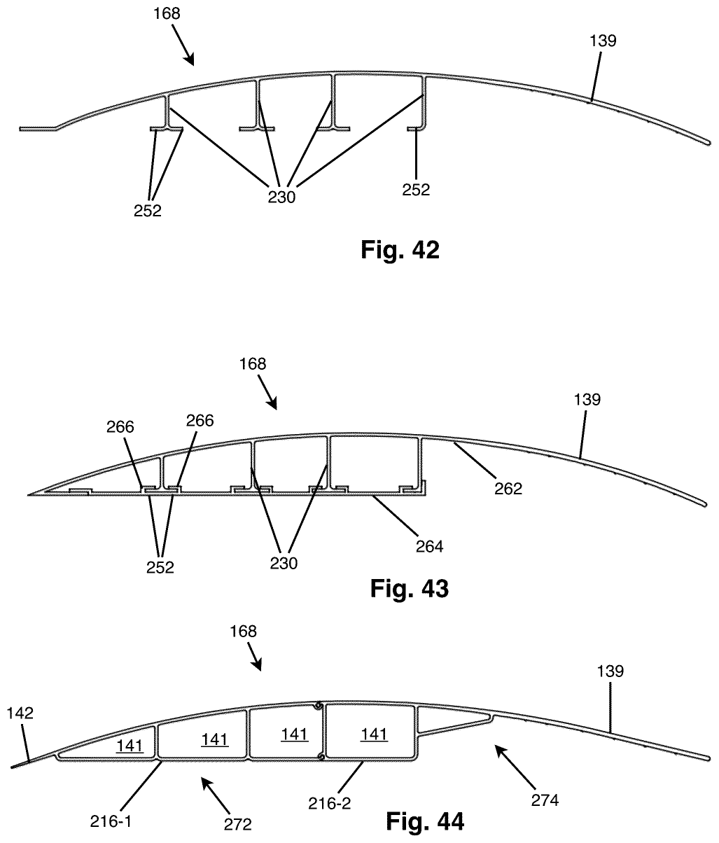

According to an embodiment, the top fairing 168 comprises at least one closed cell 141 opposed to the airflow surface 212 (e.g., FIG. 41). According to an embodiment, the top fairing 168 comprises at least one member, e.g., a plurality of members, extending from the top wall 131 (e.g., FIG. 42).

The leading edge 160 is distant from the frontmost member such that the top wall 131, frontwards to the junction of frontmost member to the top wall 131, is a cantilever portion, e.g., a front portion, or in other words a front flange 142 that is not supported as the frontmost position. According to an embodiment, the leading edge 160, when the top fairing 168 is mounted to the cargo, is designed to abut against the surface of the cargo with a load generated in the top portion biasing the leading edge 160 to remain in contact with the cargo.

Similarly, the tailing edge 121 is distant from the rearmost member with the top wall 131, rearwards to the junction of rearmost member to the top wall 131, is a cantilever portion.

According to an embodiment, the tailing edge 121 is designed to remain above the cargo, not in contact with the cargo.

According to an embodiment, at least some of the closed cells 141 are made of a section of the top wall 131, a frontmost side member 210, a rearmost side member 147, and a bottom wall 216 (e.g., FIG. 23). In a preferred embodiment, the side members 210, 147 of at least one of the cells 141 are sloped in opposed direction, one sloped frontward and the other sloped rearward, with the geometry providing resistance against shear load therefore limiting deformation of the top fairing 168.

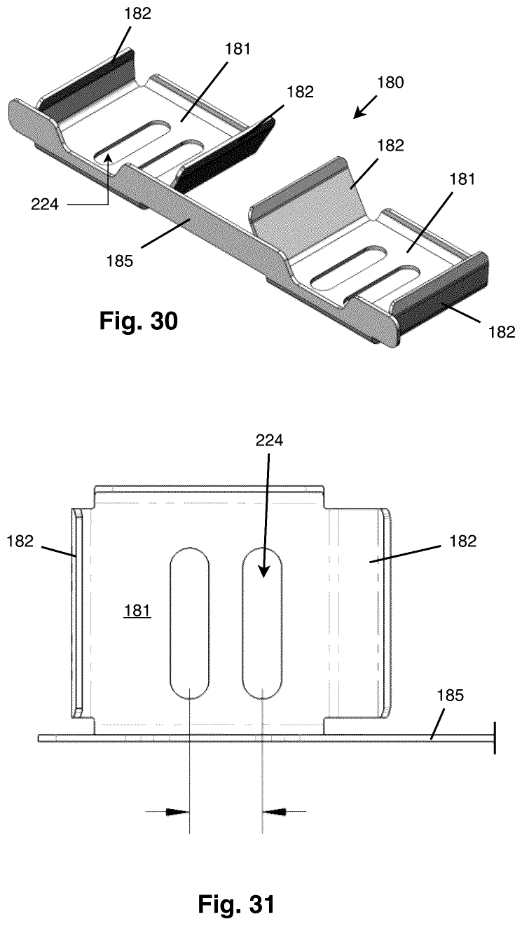

According to an embodiment, the top fairing 168 features a symmetric mounting cell, aka having the same geometry from a front perspective and a rear perspective, having symmetric abutting surface faces provided by the side members 210, 147, allowing to mount the top fairing 168 with identical brackets 180 (see e.g., FIG. 30).

According to an embodiment, the top fairing 168 features a cantilever closed cell 143 not in contact with the mounting surface 136 when the top fairing 168 is mounted thereto, providing extra structure to the top wall before the tailing cantilever portion of the top wall 131.

According to an embodiment depicted through FIG. 25, the mounting wall 216 comprises at least one of a front anti-peeling lip 155 and a rear anti-peeling lip 155 extending beyond the intersection of the mounting wall 216 to a frontmost or rearmost intersecting side member 210, 147 either frontward or rearward. The anti-peeling lip 155 is designed to be glued to the cargo.

According to an embodiment, the top wall 131 features in its tailing cantilever portion opposed to the tailing airflow surface 120 at least one longitudinal ridge 220 usable as a guide to slide a blade at its root to perform a longitudinal cut. Based on the location of the cut, it may adapt to different heights of trailer rear headers.

According to an embodiment, the front flange 142 is attached, typically glued with automotive double-face tape 162, to the mounting surface 136. According to an embodiment, the front flange 142 is glued with a continuous length of double-sided tape 162. According to an embodiment, segmented sections of double-sided tape 162 spaced apart with longitudinal sections free of tape are used.

Referring additionally to FIG. 29, according to an embodiment, the mounting wall 216 (bottommost part of the bottommost extending cells) is applied glue, e.g., automotive double-sided tape 162, thereto to mount the top fairing 168 to the mounting surface 136.

According to an embodiment, the top fairing 168 may be mounted using a combination of double-sided tape and liquid glue. Referring to FIG. 29, holes may be drilled in the mounting wall 216 for excess of glue to exit the space between the mounting wall 216 and the mounting surface 136. A tape limiting longitudinal distribution of glue may be mounted to the top fairing 168 before the application of glue.

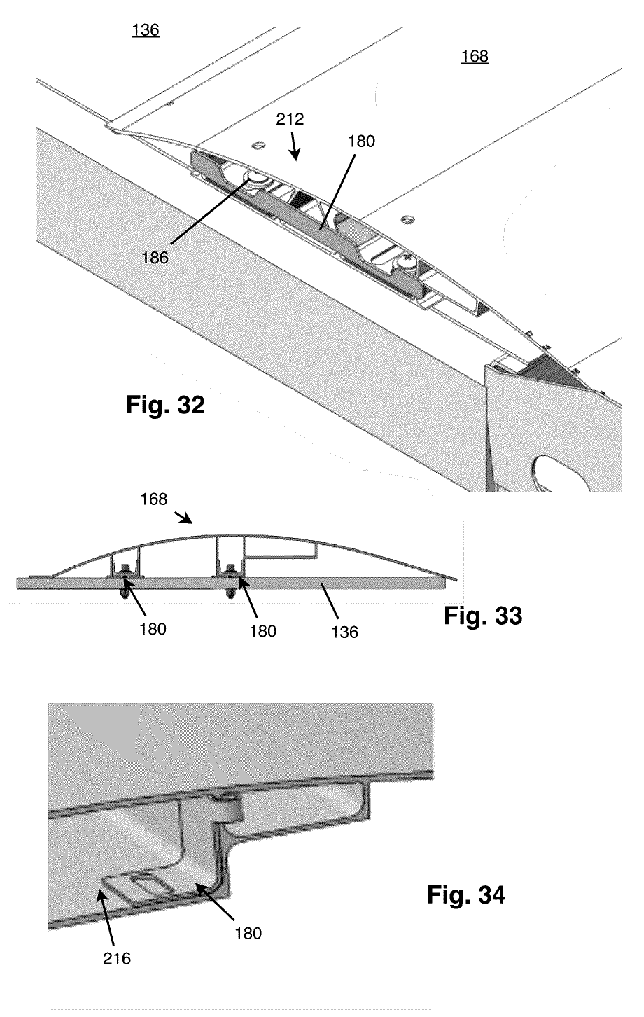

Referring additionally to FIG. 24, FIG. 30, FIG. 31, FIG. 32, FIG. 33, and FIG. 34, according to an embodiment, the top fairing 168 may be mounted using brackets 180 designed to be mounted to the mounting surface 136. The brackets 180, when mounted, are bordering the port and starboard extremities of the mounting wall 216 between the mounting surface 136 and the brackets 180. According to an embodiment, the brackets 180 have a continuous wall defining a bordering wall 181 and folded beyond into abutting walls 182 designed to abut against the members 210, 147, designed to limit displacement of the top fairing 168 in its transversal direction 165. According to an embodiment wherein brackets 180 feature a single abutting wall 182, combination of brackets 180 used to mount one extremity of the top fairing 168, port end or starboard end, provide a frontward abutting wall and a rearward abutting wall limiting together frontward and rearward displacement of the top fairing 168 in its transversal direction 165, and thus in the longitudinal direction 144 of the trailer 112.

According to a preferred embodiment, at least one, and preferably both of the top fairing 168 (cut before the installation) and the brackets 180 features oblong mounting holes 224 designed for the top fairing 168 being able to thermally expand and contract in its longitudinal direction along a longitudinal axis 228.

Use of brackets 180 allows to screw or bolt the brackets 180 to the mounting surface 136 with the head of the screws 186 located under the airflow surface 212, limiting undesired distortion of the airflow.

According to an embodiment, the brackets 180 feature a side wall 185 joining segments of the bordering wall 181.

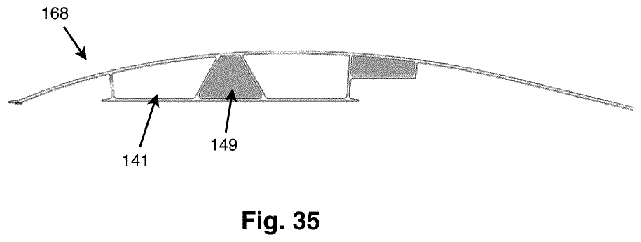

Referring to FIG. 35, according to an embodiment, porous material 149, such a foam, e.g., expanded polystyrene, is injected in at least one of the at least one closed cell 141.

According to an embodiment, the thickness of the top wall 131, the side members 210, 147 and the mounting wall 216 are at most 3 mm, and preferably less than 2 mm, and more preferably about than 1.27 mm.

According to an embodiment, the cross-section area delimited between a) the frontmost face of the frontmost cell, b) the rearmost face of the rearmost cell, c) the leading airflow 114 surface between the faces defined by these cells, and d) the mounting surface between these faces defined by these cells is preferably about 4,000 square millimeters, and most preferably about or less 3,300 square millimeters.

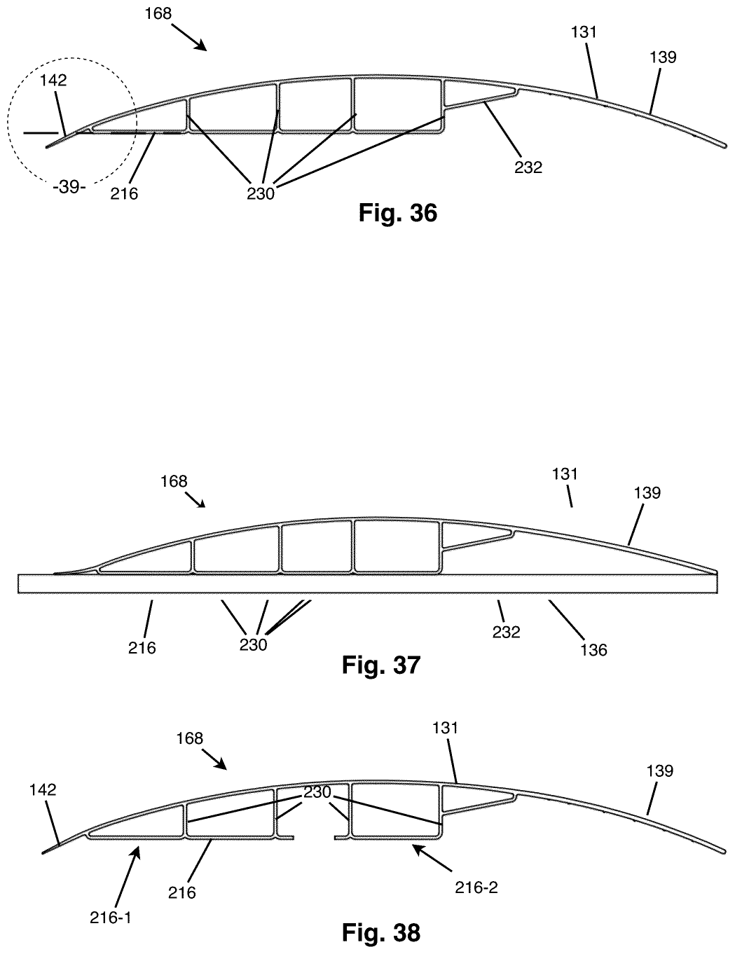

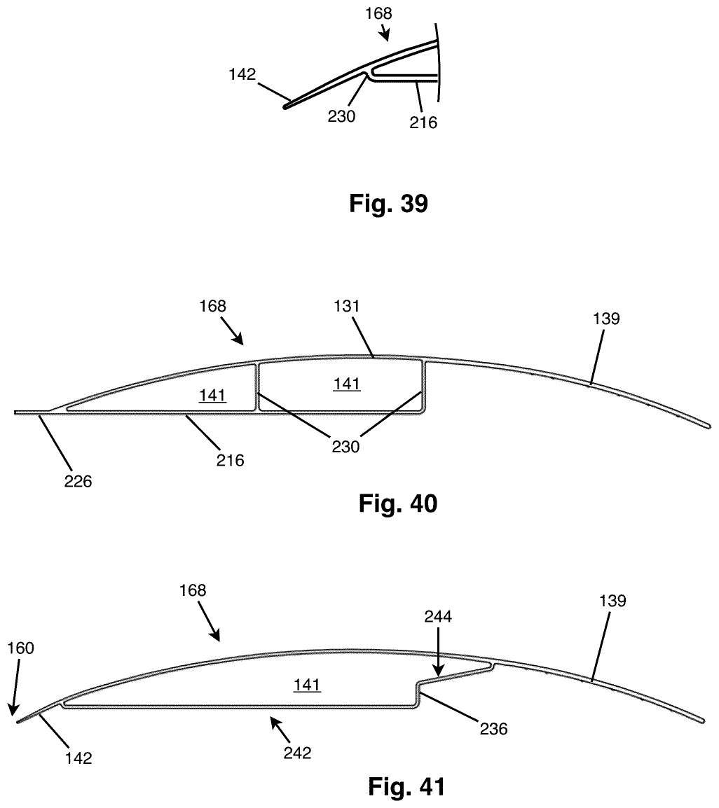

Referring to FIG. 36, FIG. 39, and FIG. 37, a top fairing 168 in accordance with another embodiment comprises a series of parallel central members 230, and an oblique member 232 joining the rearmost one of the members 230 to the cantilever portion of the top wall 131. The top fairing 168 comprises a generally flat bottom wall 216 joining the members 230 and the top wall 131 frontwards to the frontmost one of the members 230.

The front flange 142 of the top wall 131 frontward to the junction of the bottom wall 216 normally extends below the plane formed by the bottom wall 216, is flexible so as deforming when mounted to the top surface 136 to provide a flexed front flange 142 adapted to guide airflow over the fairing. Furthermore, mounting of the top fairing 168 with forces flexion of front flange 142 generates a pre-constraints on the front flange 142 that prevents the front flange 142 to rattle over the mounting surface 136.

According to an embodiment, the frontmost member 230 extends from the top wall 131 oblique to the plane of the bottom wall 216 before curving to form the front of the bottom wall 216. This configuration provides some flexibility to the front of the top fairing so that the front flange 142 may flex upwards when abutting against the cargo without breaking or without forcing the front of the bottom wall 216 to raise above the mounting surface.

According to an embodiment, a top fairing 168 features a bottom wall 216 that is substantially flat, increasing slightly the amount of material at the junctions between the bottom wall 216 and the members 230.

Referring to FIG. 38, according to an embodiment, the bottom wall 216 of the top fairing 168 may be segmented in two of more portions, e.g., a front bottom wall portion 216-1 joining the top wall 131 frontwards to the frontmost one of the members 230 and at least one other member 230, and a rear bottom wall portion 216-2 joining at least two members 230 rearwards to the front bottom wall portion 216-1.

Referring to FIG. 40, according to an embodiment, a top fairing 168 comprises less members 230, in this case two members 230, with a bottom wall 216 joining the members 230 and the top wall 131 up front. The top wall 131, up front to the junction to bottom wall 216, has flat a flat bottom surface 226 extending in the same plane as the bottom wall 216. According to this embodiment, the top wall 131 is not exerted upward, not stress loaded, by the installation of the top fairing 168 over the mounting surface 136. Accordingly, this top fairing 168 present less cells 141, with the cells being closed cells 141.

Referring to FIG. 41, according to an embodiment, the top fairing 168 comprises a single compound member 236 forming a single cell 141 under the top wall 131. The compound member 236 comprises a bottom wall portion 242 joining the top wall 131 up front about the leading edge 160, and a rear portion 244 extending upward from the bottom wall portion 242 and joining the top wall 131 upfront to a cantilever portion. According to an embodiment, the cell 141 is at least partially filled with filling material (see e.g. FIG. 35), such as polystyrene or alternative polymer, at the manufacturing step or at the installation step.

Referring to FIG. 42, according to an embodiment, the top fairing 168 comprises no closed cell. The top fairing 168 comprises a series of vertical members 230 each comprising one or more notch or lip 252 providing increased stability and surfaces usable to mount the top fairing 168 to the mounting surface 136.

Referring to FIG. 43, according to an embodiment, the top fairing 168 is made of more than one extruded parts, combined after extrusion. According to an embodiment, the top part 262 and the bottom part 264 are combined e.g., fused, with glue, and/or physically interlocked at the manufacture, before being sent for installation. According to another embodiment, the top part 262 and the bottom part 264 are glued, interlocked and/or secured to each other or to the mounting surface 136 when mounting the top fairing 168 to the mounting surface 136.

According to an embodiment, the top part 262 comprises members 230 having lips 252 at the bottom, the bottom part 264 comprises upward and sideward compound protrusions 266 defining channels in which the lips 252 are sled to mechanically secure to the parts 262, 264 together.

According to an embodiment, the bottom part 264 comprises a plurality of shorter bottom parts 264 scattered over the length of the top fairing 168, wherein the shorted bottom parts 264 may be substantially shorted than the top fairing 168, and distributed spaced from one another. The bottom parts 264 are designed to engage with the sections of the top fairing and with the top surface of the trailer. The non-engaged sections of the top faring therebetween are thereby hovering above the top surface of the trailer.

Referring to FIG. 44, according to an embodiment, the top fairing 168 is made of two parts extruded separately and secured to each other afterwards. The parts are divided into a front part 272 comprising closed cells 141 and a bottom wall 216-1, and the rear party 274 comprises closed cells 141 and a bottom wall 216-2, that are extending after assembly into a substantially flat bottom surface 216. The parts 272, 274 are secured to each other using lips inserted into channels of at least partially corresponding shape designed to retain the lip therein once inserted.

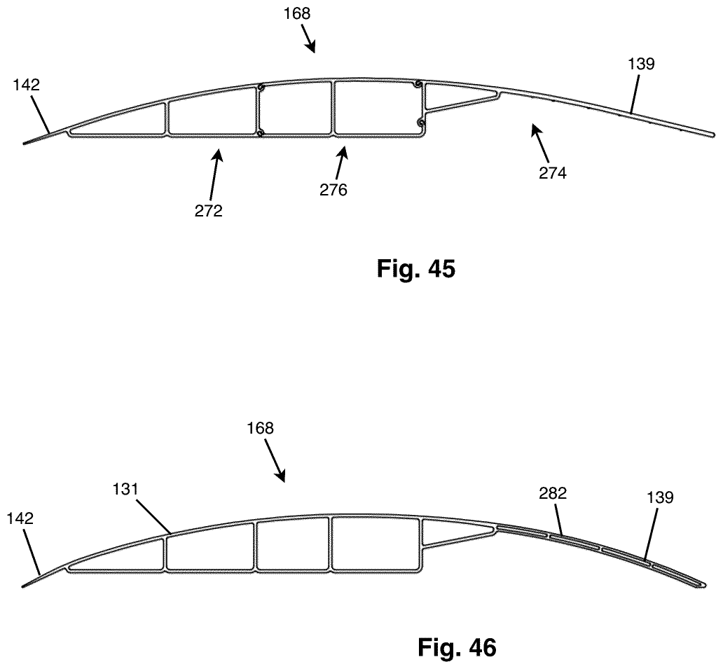

Referring to FIG. 45, according to an embodiment, the top fairing 168 comprises three (3) parts: a front part, 272, a central part 276, and a rear part 274, designed to be assembled into the operational top fairing 168.

Through the previous embodiments, the present document contemplated designs of a top fairing 168 made of one or more parts, secured to each other, wherein the parts may be divided front/rear, top/bottom, and a combination thereof.

Referring now to FIG. 46, according to an embodiment, the top fairing 168 may have a one or more sections of the top wall 131 being made of closed cells 282 increasing general thickness of this specific section of the top wall 131. Accordingly, the closed cells 282 of the top wall 131 increased the rigidity of this part of the top wall 131 with less weight increase and with less section of thicker material than with thicker wall portions of uniform density.

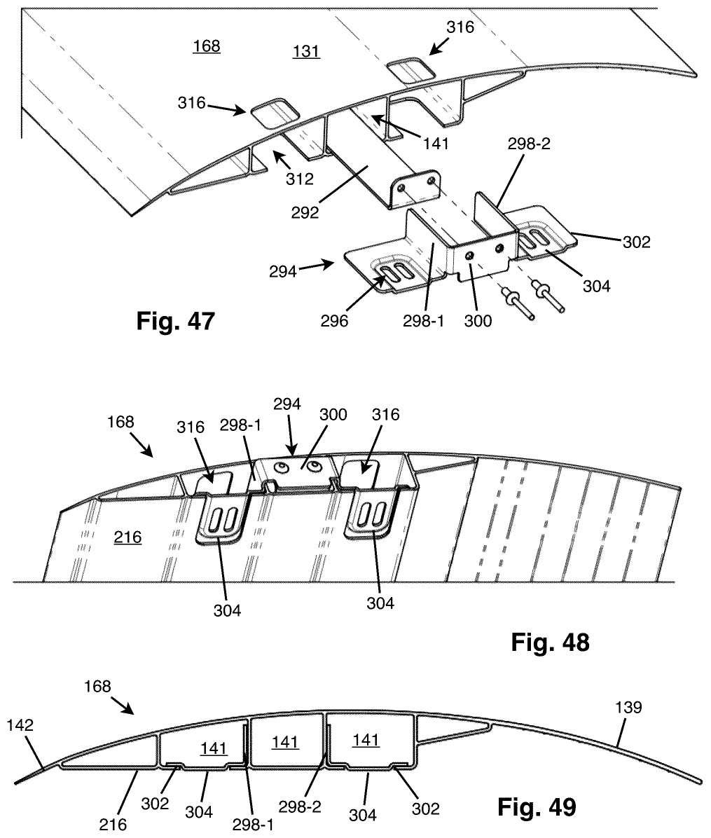

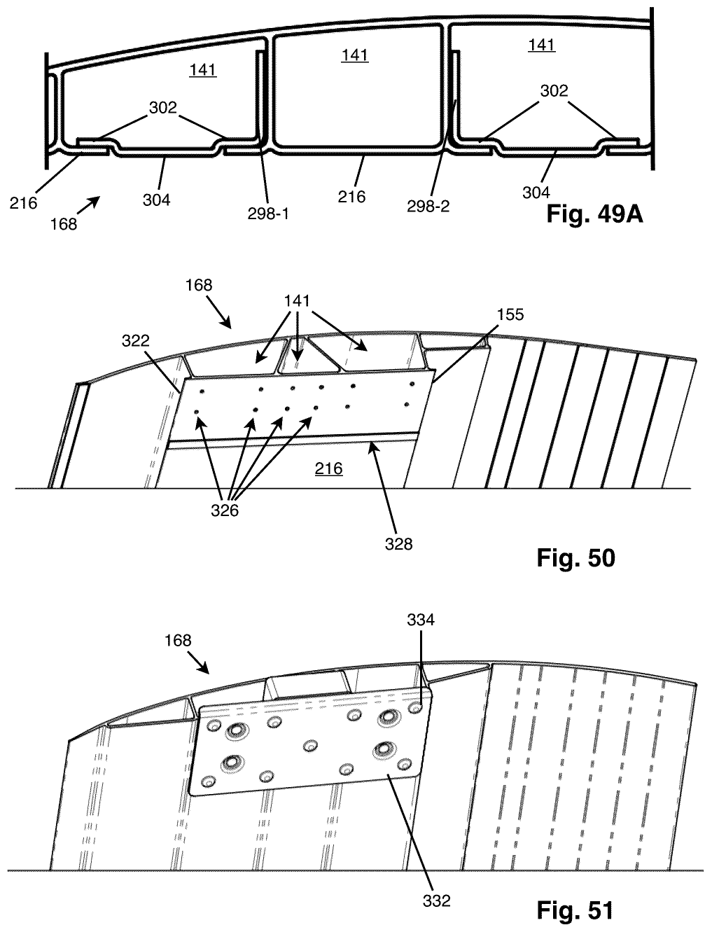

Referring to FIG. 47, FIG. 48 and FIG. 49, according to an embodiment, a mode of installation comprises a longitudinal bracket 292 inserted in a cell 141, e.g., a closed cell 141, for retaining the top fairing 168 against uplift forces resulting from air flowing over the top wall 131. An end bracket 294 is mounted at each end to the mounting surface 136 through, e.g., screws, bolts, or rivets inserted in oblong holes 296 parallel to the longitudinal direction of the top fairing 168. The oblong holes 296 allows displacement of the end bracket 294 longitudinal to the top fairing 168 to respond to thermal expansion/contraction of the material of top fairing 168. The longitudinal bracket 292 is further secured to the end bracket 294, using e.g., rivets or screws, preventing it to lift away from the mounting surface 136.

According to an embodiment, the end bracket 294 comprises a raised portion 302 around each of the securing portion 304 featuring the oblong holes 296. The top fairing 168 comprises clearances 312 corresponding to at least the securing portions 304 thereby having the top fairing 168 complementarily bordered between mounting surface 136 and the raised portion 302. The end bracket 294 further comprises longitudinal raised surfaces 298 designed to abut members, e.g. members 230 of the top fairing 168. Particularly, the end brackets 294 comprises two longitudinal raised surfaces 298 joined by a side wall 300, one longitudinal raised surface 298-1 designed to take place upfront to a member 230, and another longitudinal raised surface 298-2 designed to take place rearwards to a member 230, thereby bordering transversally the top fairing 168.

According to an embodiment, the longitudinal bracket 292 extends on a portion of the length of the top fairing 168. The longitudinal brackets 292 may connect to each other or be disconnected from each other.

According to an embodiment (not depicted), the longitudinal bracket 292 features a non-flat cross-section, such as upwards lips or a V shape increasing resistance of the longitudinal bracket 292 against flexion, and thereby against the top fairing 168 lifting about its center.

It is to be noted that the end brackets 294 may be secured about or at the edge of the top surface 136 of the trailer 112. The top fairing 168, with the leading airflow surface 114 extending below the bottom wall 216 and the longitudinal bracket 292 rigidifying the top fairing 168, is mounted with the leading edge 160 forced to contact the mounting surface 136, thereby maintaining the operative conditions for the top fairing 168.

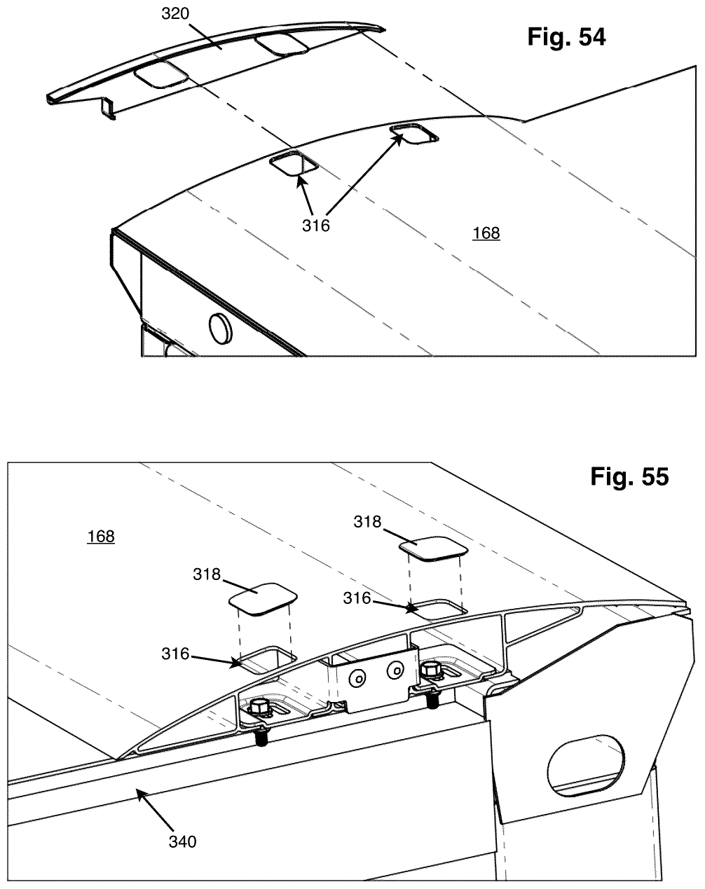

It is further to be noted that the top fairing 168 may have openings 316 cut off the top wall 131 to secure the end brackets 294 to the mounting surface 136. According to an embodiments, a single end cap 320 (FIG. 54) or caps 318 (FIG. 55) are mounted to the openings 316 once the top fairing 168 secured to the mounting surface 136.

FIG. 49 and close-up FIG. 49A show portions of the bottom wall 216 of the top fairing 168 bordered and thereby hindered between the mounting surface 136 and the end bracket 294. It further shows the raised surfaces 298 enclosing frontwards and rearwards the central one of the cells 141. The end brackets 294 are in consequence limiting frontwards/rearwards movement of the top fairing 168 while allowing longitudinal contraction/expansion thereof.

Referring to FIG. 50, according to an embodiment, a top fairing 168 installed without necessary use of a bracket. The top fairing 168 is taped and/or glued and/or secured to the mounting surface 136 of the trailer 112. The top fairing 168 comprises a notch 322 extending frontwards to the bottom wall 216, frontwards to the frontmost one of the cell 141. The top fairing 168 further comprises rearwards to the rearmost one of the cells 141 a rear anti-peel lip 155. According to embodiment, the bottom wall 216 may feature holes 326. The bottom wall 216 features a dam 328 (lengthy protrusion crossing transversally the bottom wall 216). Both holes 326 and dam 328 are features for controlling spreading of the glue over the bottom wall 216.

Referring to FIG. 51, according to an embodiment, a top fairing 168 is mounted to a mounting surface 136 using end brackets 332 of another embodiment. The end brackets 332 comprises cling studs 334 to secure the top fairing 168 to the end bracket 332, e.g., nuts are used to hold the top fairing 168. The nuts are used or comprise compression-limiting features. According to an embodiment, no longitudinal bracket is coupled thereto.

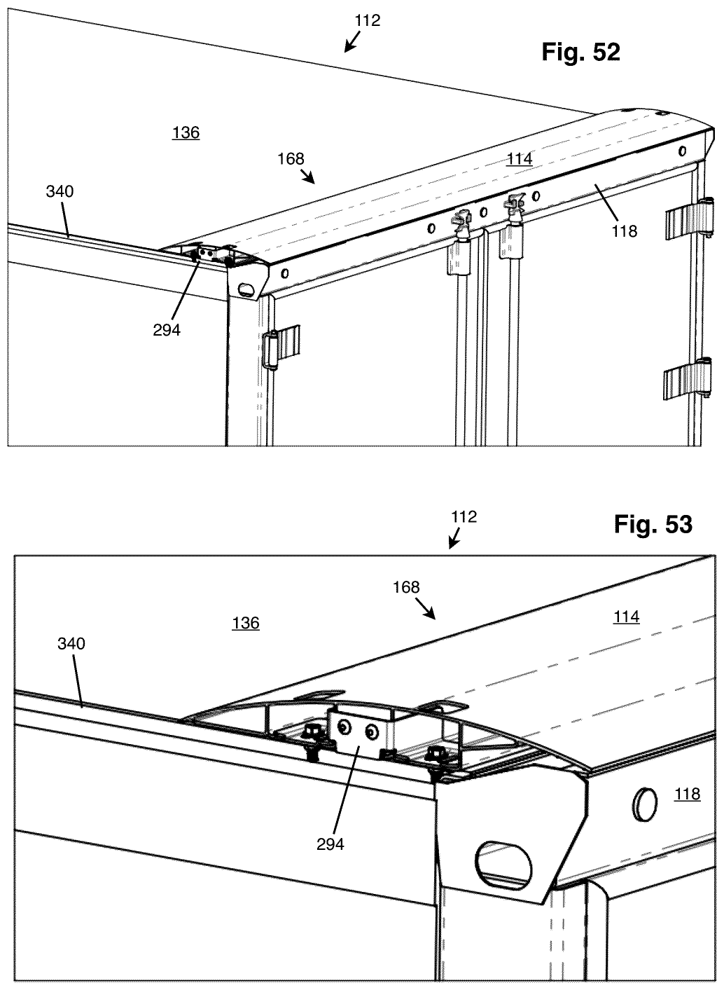

Referring to FIG. 52 and FIG. 53, these figures depict the end bracket 294 mounted to the corner rail 340 of the trailer 112. The top fairing 168 extends longitudinally to substantially cover the end bracket 294. The top fairing 168 according to an embodiment, extends transversally to extend over at least a portion of the rain gutter of the trailer 112, longitudinally relative to the trailer 112 beyond the rear doors of the trailer 112.

Exemplary installation of the top fairing 168 involves placing the top fairing 168 to extend sideways slightly less than the width of the trailer 112. Afterwards, longitudinal brackets 292 may be inserted. The end brackets 294 are inserted. The longitudinal brackets are secured to the end brackets 294. The end brackets 294 are secured to the trailer 112, generating a load in the front flange 142 of the top wall 131 that maintains contact between the leading edge 130 and the roof of the cargo body. Longitudinal raised surfaces 298 abutting against walls of cell(s) 141 of the top fairing 168 prevent the top fairing 168 to move frontwards/rearwards. The end brackets 294 further border and overlap the top fairing 168 on top of the corner rails 340, allowing longitudinal expansion/contraction of the top fairing 168 with no risk of the top fairing 168 breaking or dislodging from the brackets 294.

It is worth noting that even thus the present description presents a top fairing 168 to be installed on the roof, it is herein contemplated that in alternative embodiments a similar aerodynamic fairing assembly may be mounted to side walls of the cargo body, in a similar fashion, with no modification or small modifications of the fairing relative to the top fairing 168 that one person skilled in the art would consider without extra teaching necessary, using e.g., the described brackets 294 featuring no modification of small modifications one person skilled in the art would consider without extra teaching necessary.

Referring to FIG. 54, according to an embodiment, end caps 320 may be mounted to the ends of the top fairing 168, closing the end openings and the top openings 316 used to access the components used to secure the end brackets 294 to the trailer 112.

Referring to FIG. 55, according to an embodiment, the side openings remain unobstructed, while the top openings 316 are closed with, e.g., individual caps 318, e.g., clinging to the edge of the top openings 316.

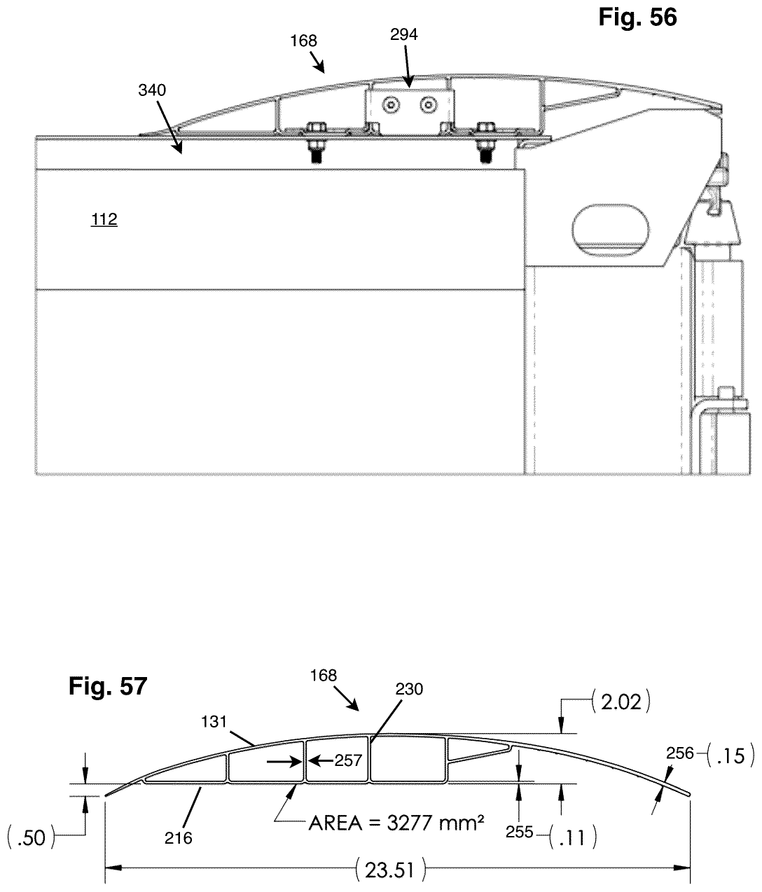

Referring to FIG. 56, the side view depicts the top fairing 168 mounted through the end brackets 294 to the corner rails 340, with the top fairing 168 comprising a rear flange 139 of the top wall 131 extending beyond the rear doors (with the exterior face of the doors being hidden by side cushions) over the rain gutter 118.

It is to be noted that, according to an embodiment, the extruded nature of the material, with a flexible front flange 142 normally extending below the bottom wall 216 provides a front leading airflow surface abutting against the mounting surface 136 of the trailer 112, thereby defining a seal against airflow. The preload resulting from the deformation of the front flange 142 of the top wall 131 further improves the response of the top fairing 168 to vibrations that result from road irregularities and airflow.

Furthermore, by changing the shape of the longitudinal bracket 292, or by adding filling with one or more of the cells 141 with expending material, or adhering material to the top wall 131 wherein facing the roof, natural frequency of the top fairing 168 may be modified to avoid the natural frequency of the trailer 112 and of the top fairing 168 to be too close to one another.

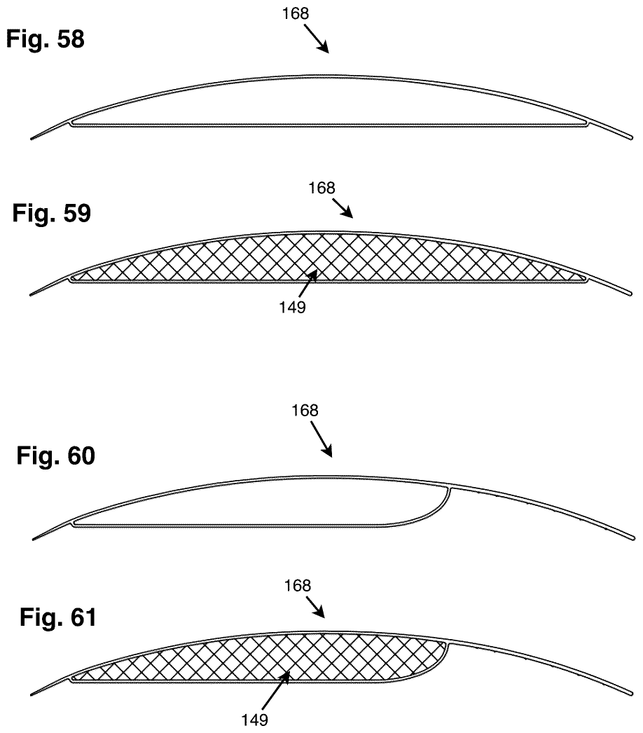

Referring to FIGS. 58-61, examples of top fairing 168 are provided wherein the fairing is manufactured and installed without filling (FIG. 58 and FIG. 60) and with filling, e.g., porous material 149 (FIG. 59 and FIG. 61).

Referring to FIG. 56, according to an embodiment, the front flange 142 of the top wall 131 has a first thickness, and the rear flange 139 of the top wall 131 has a second thickness greater than the first thickness. Therefore, the rear flange 139 is more rigid than the front flange 142.

It is to be noted that the present fairing allows to spread over almost or the whole width of the trailer 112. Such optimize spread of the top fairing allows to improve of about 15% the drag reduction efficiency due to the top fairing 168. Practically, the present top fairing 168 has a length of one hundred and two (102) inches, increasing by six (6) inches the covering provided compared to top fairings used nowadays, with no increase of the associated weight, and no additional challenges in its installation on the trailer 112.

Referring to FIG. 57, a cross-section view of an embodiment of the top fairing 168 shows that the bottom wall portion 216 has a first thickness 255 of about 0.11 inches, and that the top wall 131 has a relatively constant thickness 256 between leading edge 160 and the tailing edge 121 of about 0.15 inches. According to an embodiment, the members 230 have a thickness 257 that is about the same as the bottom wall portion 216.

According to an embodiment, the area or material of the top fairing is at most 4000 mm², or in other words the material used to manufacture the top fairing 168 is at most 4000000 mm³ per longitudinal meter of top fairing 168 (4 cm³ per longitudinal meter of top fairing). According to an embodiment, material is less than 3.75 cm³ per longitudinal meter, and preferably less than 3.50 cm³ per longitudinal meter.

According to an embodiment, the leading edge 160 extends below the bottom wall portion 216 at least 0.10 inches perpendicular to the bottom wall portion 216, and preferably at least 0.30 inches, and more preferably about 0.50 inches.

According to embodiments, the area enclosed by the top fairing between the top wall 131 and the mounting surface of the cargo along a plane transversal to the top fairing 168 is at most 30000 mm², and preferably at most 25000 mm², and most preferably about 20300 mm².

In a preferred embodiment, the method of manufacture of the top fairing 168 comprises having a mold defining a space for a top wall 131 providing an airflow surface, and spaces for at least one cell 141 comprising a portion of the top wall 131 and members, and extruding material through the mold to obtain a top fairing 168. Afterwards, the method involves cutting the top fairing to the width of the trailer to be mounted to. It may include to cut/generate openings for passing tools for mounting the top fairing 168 to the trailer 112, or for interface with e.g. end brackets 294.

A method of used of the top fairing 168 comprising to mount the top fairing 168 to a mounting surface 136 of a trailer 112 through glue, brackets 180, or a combination thereof.

While preferred embodiments have been described above and illustrated in the accompanying drawings, it will be evident to those skilled in the art that modifications may be made without departing from this disclosure. Such modifications are considered as possible variants comprised in the scope of the disclosure.

1. An aerodynamic fairing for a body of a cargo container, comprising:
a top wall providing an airflow leading surface, extending from a leading edge to a tailing edge thereof, in a transversal direction of the aerodynamic fairing, and from a first extremity to a second extremity thereof in a longitudinal direction along a longitudinal axis;
a first member extending from the top wall away from the leading airflow surface, the first member providing a bottom wall extending distant to the top wall that provides a mounting surface to abut directly or indirectly against the cargo body,
wherein, from where the top wall is joining the first member to the leading edge, the top wall comprises a front portion that is cantilevered,
and
wherein the aerodynamic fairing features a profile according to a plane perpendicular to the longitudinal axis, the profile being substantially constant over most of its length spanning between the first extremity and the second extremity.

2. The aerodynamic fairing of claim 1, wherein, from where the top wall is joining the first member to the tailing edge, the top wall comprises a rear portion that is a cantilevered.

3. The aerodynamic fairing of claim 1, wherein the first member is a compound member.

4. The aerodynamic fairing of claim 1, further comprising a second member that couples the top wall to the first member.

5. The aerodynamic fairing of claim 1, wherein the first member extends perpendicular to the top wall where the first member joins the top wall.

6. The aerodynamic fairing of claim 1, wherein the first member extends oblique to the top wall where the first member joins the top wall.

7. The aerodynamic fairing of claim 1, wherein the first member extends oblique to the mounting surface with at least a portion of the first member that is sloped frontwards, and further comprising a second member that extends oblique to the mounting surface with at least a section of the second member that is being sloped rearwards.

8. The aerodynamic fairing of claim 1, wherein the mounting surface defines a mounting plane, and wherein the top wall crosses the mounting plane frontwards to the first member.

9. The aerodynamic fairing of claim 1, wherein the top wall has a first average thickness frontwards to the first member, and a second average thickness rearwards to the first member, wherein the first average thickness is smaller than the second average thickness.

10. The aerodynamic fairing of claim 2, wherein the front portion of the top wall is shorter than the rear portion of the top wall.

11. The aerodynamic fairing of claim 1, further comprising a second member, wherein the bottom wall joins the first member to the second member, thereby defining a closed cell.

12. The aerodynamic fairing of claim 11, wherein the first member and the second member are extending along parallel planes.

13. The aerodynamic fairing of claim 1, further comprising a second member extending from the top wall, wherein the mounting surface defines a mounting plane, and wherein the leading airflow surface has an apex relative to the mounting surface located between wherein the first member and the second member are joining the top wall.

14. The aerodynamic fairing of claim 1, comprising a front edge and a rear edge, and wherein the top wall is a unitary body spanning between the front edge, the rear edge, the first extremity and the second extremity.

15. The aerodynamic fairing of claim 1, comprising a first component and a second component that when secured together form the aerodynamic fairing.

16. The aerodynamic fairing of claim 15, wherein the first component comprises at least one channel and the second component comprises at least one prong for inserting into the at least one channel to secure the first component to the second component.

17. The aerodynamic fairing of claim 11, further comprising a filling material adhered to the top wall about the first member.

18. The aerodynamic fairing of claim 1, wherein the aerodynamic fairing is made predominantly of at least one of polymer and of a composite material.

19. The aerodynamic fairing of claim 1, wherein at least one of the top wall and the first member has a thickness of at most 10 mm.

20. The aerodynamic fairing of claim 1, wherein an area of the profile of the aerodynamic fairing delimited within the leading airflow surface, a mounting plane in which extends the mounting surface, and lines perpendicular to the mounting plane joining the mounting plane to the leading airflow surface has a dimension of between about 3000 mm2 and 5000 mm2.

21. The aerodynamic fairing of claim 1, wherein the bottom wall of the aerodynamic fairing is glued to the cargo container.

22. An aerodynamic fairing assembly to be mounted to a body of a cargo container, comprising:
a) an aerodynamic fairing comprising:
i) a top wall providing an airflow leading surface extending from a leading edge to a tailing edge in a transversal direction, and from a first extremity to a second extremity in a longitudinal direction along a longitudinal axis; and
ii) a first member extending from the top wall away from the leading airflow surface, the first member providing a bottom wall extending distant to the top wall that provides a mounting surface to abut directly or indirectly against the cargo body;
b) an end bracket for mounting the aerodynamic fairing to the body of the cargo container, the end bracket comprising:
i) a mounting portion for securing to the body of the cargo container; and
ii) a bordering portion for bordering at least part of the bottom wall of the aerodynamic fairing therebetween and the body of the cargo container.

23. The aerodynamic fairing assembly of claim 22, further comprising at least one raised portion abutting the aerodynamic fairing distant to the first member between the leading edge and the tailing edge.

23. The aerodynamic fairing assembly of claim 22, further comprising a longitudinal bracket secured to the end bracket.

24. The aerodynamic fairing assembly of claim 22, further comprising an end cap at least partially closing an opening between the top wall and the bottom wall.

25. The aerodynamic fairing assembly of claim 22, wherein the aerodynamic fairing consists of a multi-piece extrusion.

26. A vehicle comprising an aerodynamic fairing mounted to a body of a cargo container of the vehicle, the aerodynamic fairing comprising:
a top wall providing an airflow leading surface extending from a leading edge to a tailing edge in a transversal direction of the aerodynamic fairing, and from a first extremity to a second extremity in a longitudinal direction of the aerodynamic fairing along a longitudinal axis;
a first member extending from the top wall away from the leading airflow surface, the first member providing a bottom wall extending distant to the top wall that provides a mounting surface to abut directly or indirectly against the body of the cargo container,
wherein, from where the top wall is joining the first member to the leading edge, the top wall comprises a front portion that is a cantilevered and biased to abut against the cargo container,
wherein the aerodynamic fairing when mounted to the body of the cargo container, has the bottom wall and the leading edge abutting against the cargo container.
